(19) United States
(12) Patent Application Publication
(10) Pub. No.: US 2014/0011513 A1
(43) Pub. Date: Jan. 9, 2014

(54) Mobile Device Location Estimation Using Operational Data of a Wireless Network

(71) Applicants: Nancy Hickey Watts, Marietta, GA (US); Carlos Alberto Roman Saavedra, Atlanta, GA (US); Richard Jhonson Rossel Quezada, Atlanta, GA (US)

(72) Inventors: Nancy Hickey Watts, Marietta, GA (US); Carlos Alberto Roman Saavedra, Atlanta, GA (US); Richard Jhonson Rossel Quezada, Atlanta, GA (US)

(21) Appl. No.: 13/931,558

(22) Filed: Jun. 28, 2013

Related U.S. Application Data
(63) Continuation-in-part of application No. 13/448,146, filed on Apr. 16, 2012.
(60) Provisional application No. 61/666,678, filed on Jun. 29, 2012.
(60) Provisional application No. 61/475,878, filed on Apr. 15, 2011.

(51) Int. Cl. H04W 4/02

(52) U.S. Cl. CPC H04W 4/02
USPC 455/452.2; 455/456.1

(57) ABSTRACT

A method for location estimation of a mobile device using operational data of a wireless network includes creating a geospatial model of a wireless network. The geospatial model may include a geometry representative of coverage area of each antenna in the wireless network. The geometry may be created, by the modeling module, based on a tower data of the wireless network and an operational data from the wireless network. The geospatial model may further include range bands for each antenna, created based on the operational data. In addition, the method includes receiving, by the modeling module, a model of a plurality of sites for an area of the wireless network. Further, the method includes determining, by a location module, the location of the mobile device in the wireless network based on the geospatial model of a wireless network, the geospatial model of geospatial features and real-time operational data.

### CROSS REFERENCE TO RELATED APPLICATIONS

This application claims priority under 35 U.S.C. §119 to U.S. Provisional Patent Application No. 61/666,678 filed Jun. 29, 2012 entitled “Mobile Device Location Estimation Using Operational Data of A Wireless Network,” the entire contents of which are hereby incorporated herein by reference.

This application is also a continuation-in-part to U.S. patent application Ser. No. 13/448,146 filed Apr. 16, 2012 entitled “Mobile Device Location Estimation Using Operational Data of a Wireless Network,” which claims priority under 35 U.S.C. §119 to U.S. Provisional Patent Application No. 61/475,878 filed Apr. 15, 2011 entitled “Mobile Device Location Estimation from Cell Network Signaling Data,” the entire contents of each of which are hereby incorporated herein by reference.

### FIELD OF INVENTION

This disclosure relates generally to a technical field of location estimation and, in one example embodiment, to a system, method and an apparatus for mobile device location estimation using operational data of a wireless network.

### BACKGROUND

Location based services (LBS) may be an emerging trend in today's digital world. A variety of businesses may use LBS to strategically reach existing and/or potential customers. For example, a restaurant may use location information of a user to offer attractive discounts to a user, when the user is in a vicinity of the restaurant. In another example, location of users commuting on a specific route may be used to determine the meaningful travel information (e.g., speed of traffic, congestion, etc.) on that route, which when provided to a user may save commute time of the user. Example of other contexts that LBS are used may include health, indoor object search, entertainment, work, and/or personal life. LBS may depend on location of a mobile communication device.

Conventional technologies often use global Positioning System (GPS) device to determine positions of mobile communication devises and transmit these data via a wireless network to businesses. While this approach may give accurate information for a small number of devices, any attempt to gather positioning information from a large number of devices may use up large amounts of scarce bandwidth from the wireless network. Further, the said approach may be cost intensive and gathering all the GPS data may be time intensive as well. Further, GPS data may not be available in locations where LBS may be used extensively such as urban cities where high elevation buildings block access to a clear sky.

On the other hand, wireless technologies may have a vast infrastructure of communication facilities that generate data routinely to enable the system to properly function, e.g., to enable cellular phone users to place and receive calls and stay connected to these calls as they move though the cell sectors of a system. Examples of these data include signaling data, call detail records (CDR), handover messages, and/or registration messages. In view of the foregoing, there is a need for a technology for location estimation of mobile communication devices based on data from wireless networks.

### SUMMARY

Disclosed are a method, system and apparatus for mobile device location estimation using operational data of a wireless network. In one aspect, a method includes creating, for each antenna of a plurality of antennas in an area associated with a wireless network, a sector geometry representative of a coverage area of each antenna. The sector geometry may be created based on a tower data of the wireless network and first operational data from the wireless network. Further, the method includes, generating, for each antenna, one or more range bands, each bound by a first distance and a second distance. The range bands may be generated based on the first operational data. Furthermore, the method includes, receiving a model of a plurality of sites for the area associated with the wireless network. In addition, the method includes, estimating a location of a mobile device in the wireless network based on the sector geometry of one or more antennas from the plurality of antennas, the one or more range bands of each of the selected one or more antennas, the model of the plurality of sites, and second operational data.

In another aspect, a position determination engine includes a memory and a processor. The processor is configured to create, for each antenna of a plurality of antennas in an area associated with a wireless network, a sector geometry representative of a coverage area of each antenna. The sector geometry may be created based on a tower data of the wireless network and first operational data from the wireless network. Further, the processor is configured to receive a geospatial model of a plurality of sites for the area associated with the wireless network. Furthermore, the processor is configured to estimate a location of a mobile device in the wireless network. The location may be estimated based on the sector geometry of one or more antennas selected from the plurality of antennas, the geospatial model of the plurality of sites, and second operational data.

In yet another aspect, a system comprises a position determination engine. The position determination engine includes a modeling module and a location module. The modeling module of the position determination engine is configured to create, for each antenna of a plurality of antennas in an area associated with a wireless network, a sector geometry representative of a coverage area of each antenna. The sector geometry may be created based on a tower data of the wireless network and historical signaling data from the wireless network. Further, the modeling module may be configured to receive a geospatial model of a plurality of sites for the area associated with the wireless network. In addition, the modeling module may be configured to generate, for each antenna, one or more range bands. Each range band is bound by a first distance and a second distance and the range band is generated based on the historical signaling data. Further, the location module may be configured to estimate a location of a mobile device in the wireless network. The location of the mobile device may be estimated based on the sector geometry of one or more antennas selected from the plurality of antennas, the geospatial model of the plurality of sites, the one or more range bands of the at least one antenna, and real-time signaling data obtained from the wireless network.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

Example embodiments are illustrated by way of example and not limitation in the figures of accompanying drawings, in which:

FIG. 1 illustrates an operating environment for the position determination engine, according to certain exemplary embodiments of the present invention.

FIG. 2 illustrates a block diagram of the position determination engine of FIG. 1, according to certain exemplary embodiments of the present invention.

FIG. 3 illustrates an operational overview of the position determination engine process, according to certain exemplary embodiments of the present invention.

FIG. 4A illustrates a block diagram of the parser module of the position determination engine, according to certain exemplary embodiments of the present invention.

FIG. 4B illustrates a process of the parser module, according to certain exemplary embodiments of the present invention.

FIG. 5A illustrates a block diagram of the modeling module of the position determination engine, according to certain exemplary embodiments of the present invention.

FIG. 5B illustrates a process of the modeling module for creating geospatial models and associated cellular network sector database, according to certain exemplary embodiments of the present invention.

FIGS. 6A-6C is a graphical representation of the process of generating geospatial model of cellular network coverage, according to certain exemplary embodiments of the present invention.

FIG. 6D presents a graphical representation of overlay of cell sector coverage map database elements, according to certain exemplary embodiments of the present invention.

FIG. 6E presents a graphical representation of overlay of cell sector coverage map database elements including the ring venue geometry, according to certain exemplary embodiments of the present invention.

FIG. 7A illustrates a block diagram of the location module of the position determination engine, according to certain exemplary embodiments of the present invention.

FIG. 7B illustrates a process of the location module for location estimation, according to certain exemplary embodiments of the present invention.

FIGS. 8A-8D (collectively FIG. 8) illustrates a process of determining common region for location estimation of a mobile device based on information from multiple antennas, according to certain exemplary embodiments of the present invention.

FIGS. 9A-9D are graphical representations of the location estimation process using information from one or more antennas, according to certain exemplary embodiments of the present invention.

FIG. 10A-10D (collectively FIG. 10) illustrates a block diagram of the modeling module of the position determination engine including a ring venue module, according to certain exemplary embodiments of the present invention.

FIGS. 11-13 is a graphical representation of the location estimation process using information from one antenna and a venue geometry, according to certain exemplary embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

Disclosed are a system, a method and an apparatus for mobile device location estimation using operational data of a wireless network. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

The term ‘site’ may generally refer to spatial location of a facility, a building, and/or a structure. In one embodiment, the site may refer to a point of interests within a given area. In an example embodiment, the site may include, but is not limited to, an amusement park, a restaurant, an apartment complex, a house, a hospital, a stadium, etc. The term site may be interchangeably used as venue within this disclosure without departing from the broader scope of the disclosure.

The term ‘operational data’ as used herein, may generally refer to any appropriate record representative of signaling operation between an antenna (of a cellular tower) and a mobile device. In one embodiment, the operational data may include a record of signaling events. In an example embodiment, signaling events may differ based on a carrier provider. For example, carrier A may generate signaling events at the beginning and end of a call, whereas carrier B may generate signaling events at periodic intervals during the call. Each signaling event may include signaling data that may further include, inter alia, round trip delay data, signal strength data, phase data, cellular/tower identifier, and/or sector identifier, etc.

The term ‘first operational data’ as used herein may generally refer to signaling data. The first operational data may be signaling data collected at a first time. In one example embodiment, the first operational data may be used to determine the coverage area of an antenna. In another example embodiment, the first operational data may be used to estimate the location of the mobile device as well. In the following description, the first operational data may be interchangeably referred to as historical operational data or historical signaling data without departing from the broader scope of the disclosure. In some embodiments, the first operational data may be signaling data that is collected over a pre-determined period of time or received from an external source as a batch data.

The term ‘second operational data’ as used herein may generally refer to signaling data. The second operational data may be signaling data that is collected at a second time. In an example embodiment, the second operational data may be used to estimate a location of the mobile device. In another example embodiment, the second operational data may be used to determine the coverage area of antennas in the network along with determining the location of the mobile device. In the following description, the second operational data may be interchangeably referred to as real-time operational data or real-time signaling data without departing from the broader scope of the disclosure. In some embodiments, the second operational data may be signaling data that is collected or received in near real-time (disregarding any processor or network delays).

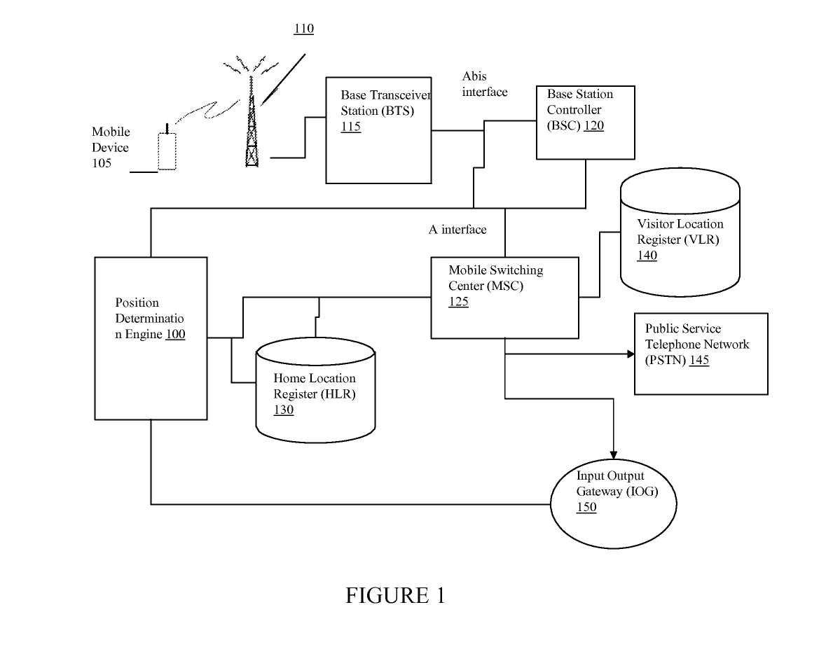

Technology of mobile device location estimation using operational data of a wireless network will be described below in detail using various embodiments. The location may be estimated using a position determination engine which will be described in greater detail in association with FIGS. 1-3. The position determination engine may be configured to receive operational data. In addition, the position determination engine may be configured to receive information associated with geographical features (may interchangeably referred to as ‘geographical feature information’ in the following description) within an area associated with the coverage of a wireless network. Such information may include geometries representative of roads and venues within a network coverage area of a wireless network. The venues may include any appropriate point of interest. For example, the different venues may include, inter alia, a stadium, a shopping mall, an office space, an arena, a museum building, or a restaurant. Even though the following description specifically mentions roads and venues, one of ordinary skill in the art can understand and appreciate that the position determination engine can use any geographical and/or geospatial feature both instead of or in addition to the roads and venues to assist in estimating the location.

Upon receiving the operational data and the information representative of the geographical features, the position determination engine may process the received operational data along with the received geographic feature information to determine a location estimate of a mobile device.

In an example embodiment, the position determination engine may include a data extraction module, a modeling module, a parser module, and/or a location module. The data extraction module of the position determination engine may be configured to receive and/or extract operational data from various element of a wireless network, such as a base station controller, a base transceiver station, and/or other network elements that handle or store signaling data. In one embodiment, the data extraction module may be configured to extract the first operational data and/or the second operational data.

Once the first operational data is extracted, the parser module may parse the extracted first operational data to retrieve a desired signaling data from the operational data. Using the retrieved signaling data, the modeling module may determine coverage area of each antenna within the geographic area associated with the coverage of the wireless network (or cellular network). Responsive to determining the coverage area of each antenna, the modeling module may generate a sector geometry that represents the coverage area of each antenna within the geographic area associated with the coverage of the wireless network.

In addition to the sector geometries, the modeling module may generate polygons or geometries representative of each road within the geographic area associated with the coverage of the wireless network. Further, in one embodiment, the modeling module may receive geometries representative of venues (may interchangeably referred to as ‘venue geometries’) and the location of each venue within the geographic area associated with the coverage of the wireless network. After receiving the venue geometries and their respective locations within the geographic area, the modeling module may determine a list of antennas that service each venue represented by their respective venue geometry. In an example embodiment, one or more antennas may service a venue. In another embodiment, upon receiving venue locations, the modeling module can generate polygons representative of the venues within the geographic area covered by the wireless network system.

After receiving and/or generating the venue geometries, the modeling module may be configured to assign ranks or weights to each venue geometry based on one or more predetermined criteria. The one or more predetermined criteria can include, inter alia, number of times mobile devices were located within the venue in previous location estimations, number of antennas servicing the venue, type of venue, location of venue and/or size of venue. In an example embodiment, the assignment of ranks and/or weights can be changed dynamically based on certain criteria, such as time of year, time of day, and/or an event. For example, a venue geometry representative of an amusement park may be assigned more weight in summer than in winter. In another example, on a game day, the rank assigned to a venue geometry representative of a stadium may be higher than the rank assigned to the venue geometry representative of an apartment complex.

Upon generation of the different geometries and assignment of weights, the modeling module may store the different geometries such as sector geometries, geometries representative of the roads, and venue geometries in a cell sector coverage map database. In addition, the modeling module may store the list of antennas that service each venue and the rankings of each venue in the cell sector coverage map database.

Once the cell sector coverage map database has been populated, the data extraction module of the position determination engine may be configured to extract the second operational data. Further, the parser module may parse the second operational data to retrieve a signaling data associated with a mobile device of interest. The retrieved signaling data may be processed to determine a list of antennas that service the mobile device of interest. In addition, the location module may search the cell sector coverage map database to check if any of the determined list of antennas that service the mobile device are listed as antennas that service a venue as well. If so, the venue is used for location estimation of the mobile device. In some embodiments, the venue may be assigned as the location of the mobile device. In other embodiments, the location may be further refined by intersecting the venue geometry with sector geometries, geometries representative of the roads, and other attributes. One of ordinary skill in the art can understand and appreciate that constraints may be added or removed as desired to obtain a location estimation of the mobile device of interest without departing from the broader scope of this disclosure.

In some embodiments, there may be one or more location estimates for a given mobile device of interest. If there are more than one location estimates, the position determination engine may apply error values to each determined position and subject the multiple location estimates to additional refinement to generate a more accurate location estimation.

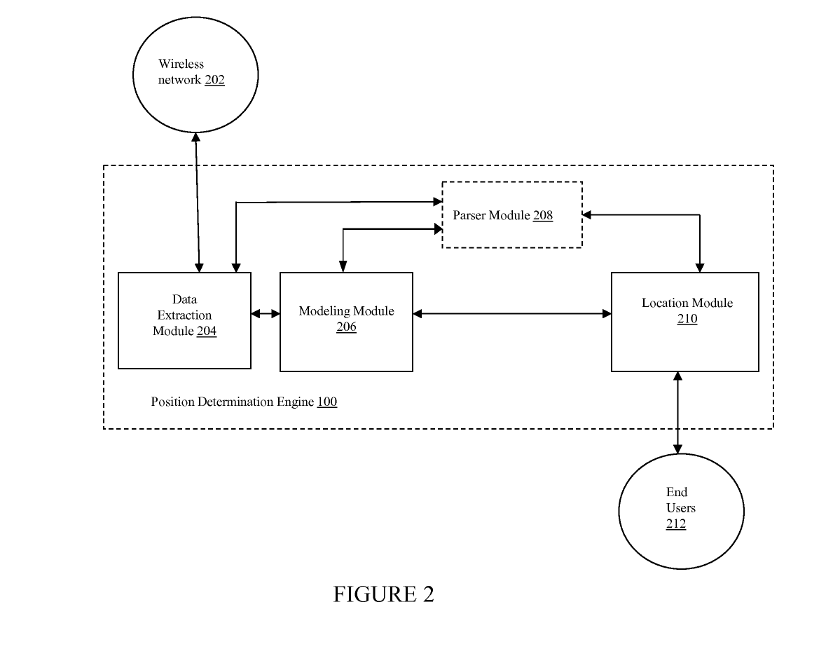

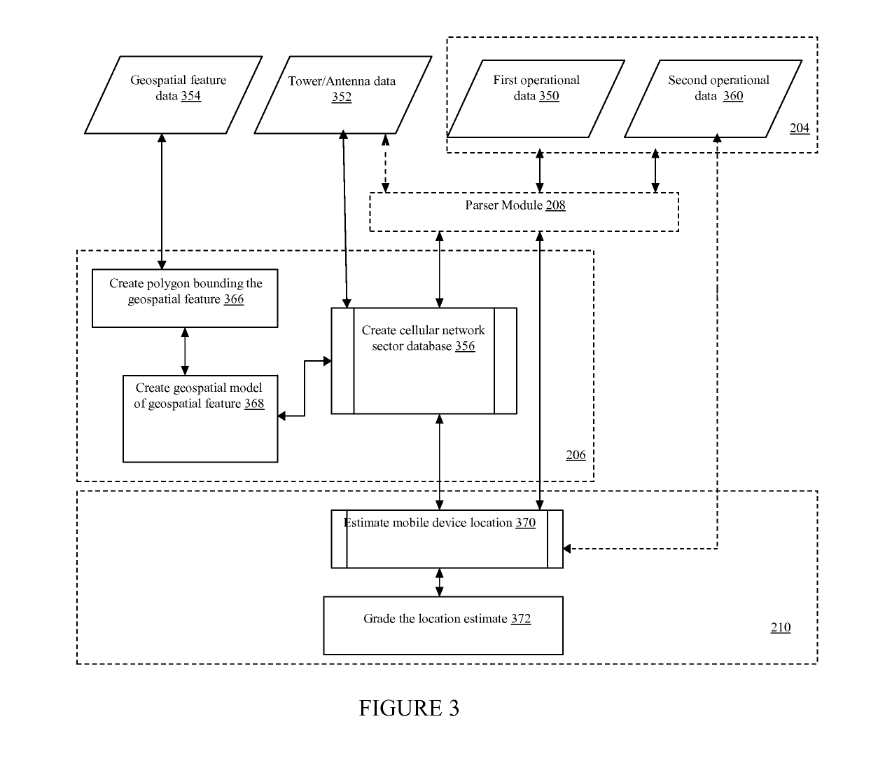

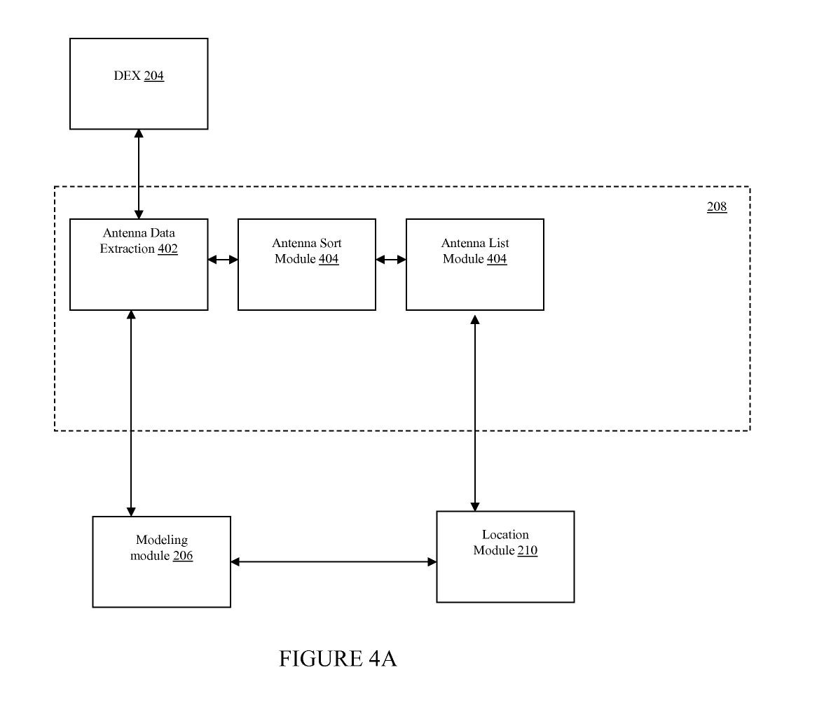

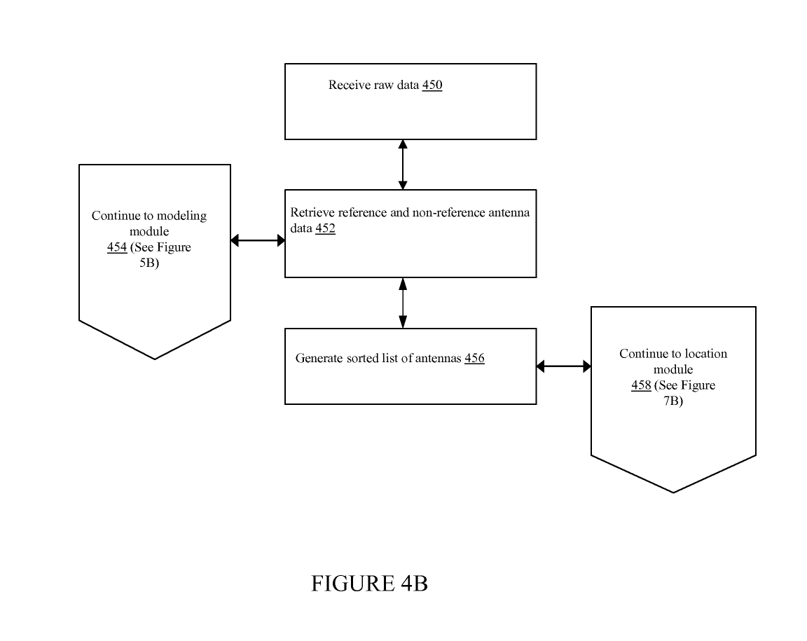

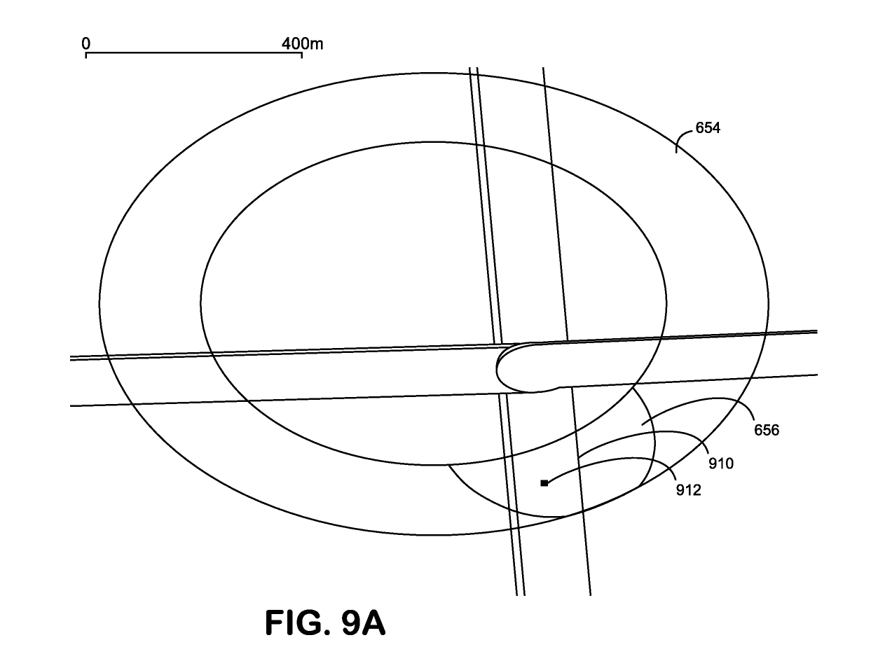

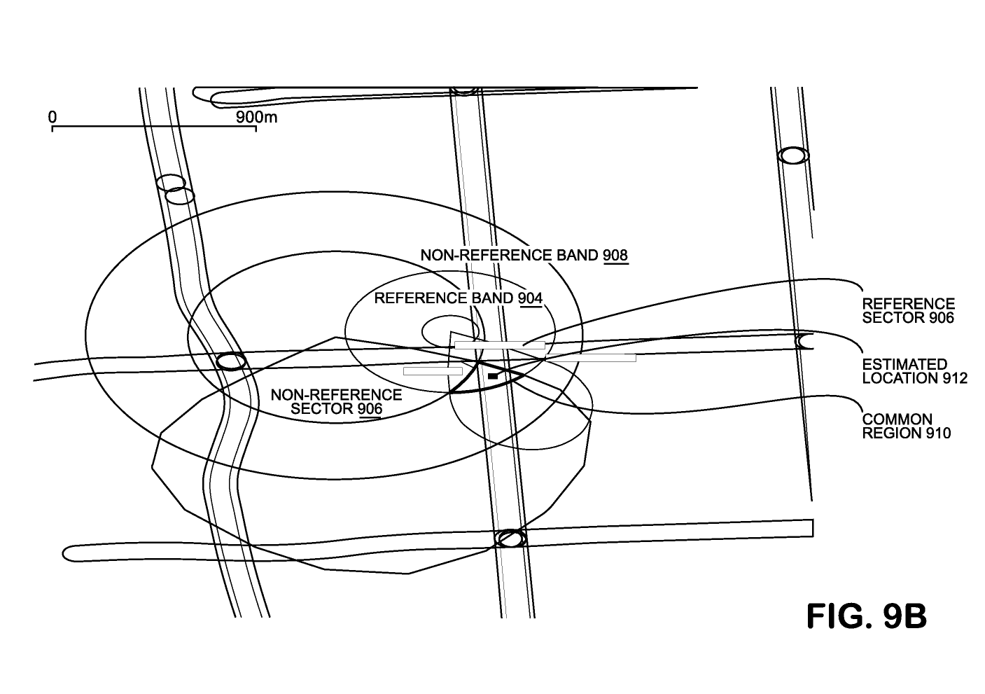

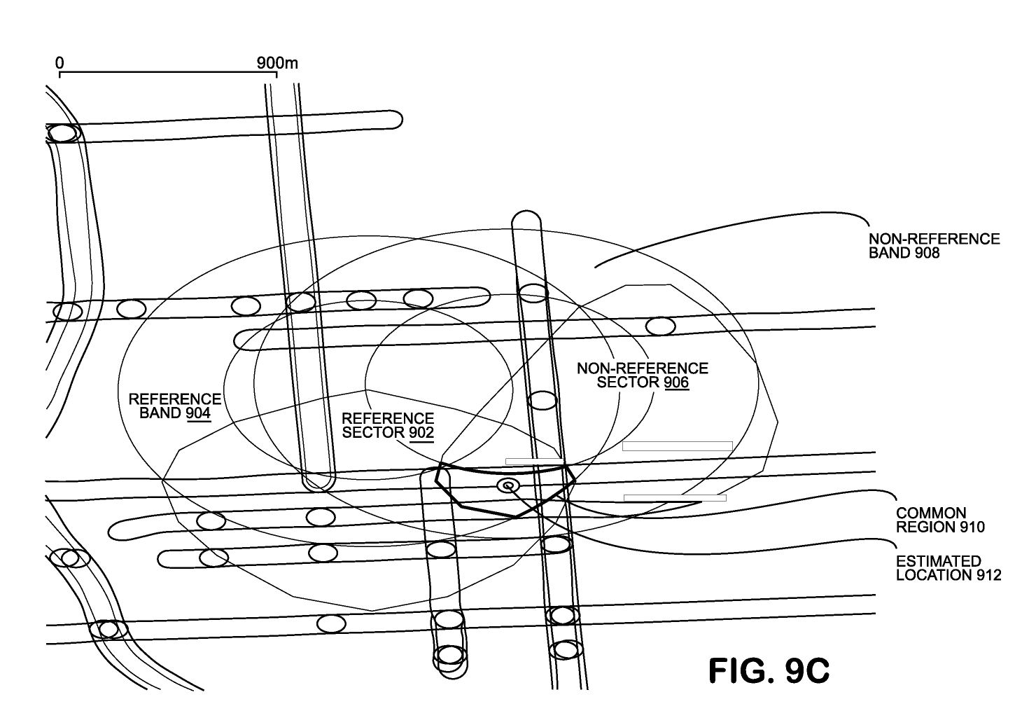

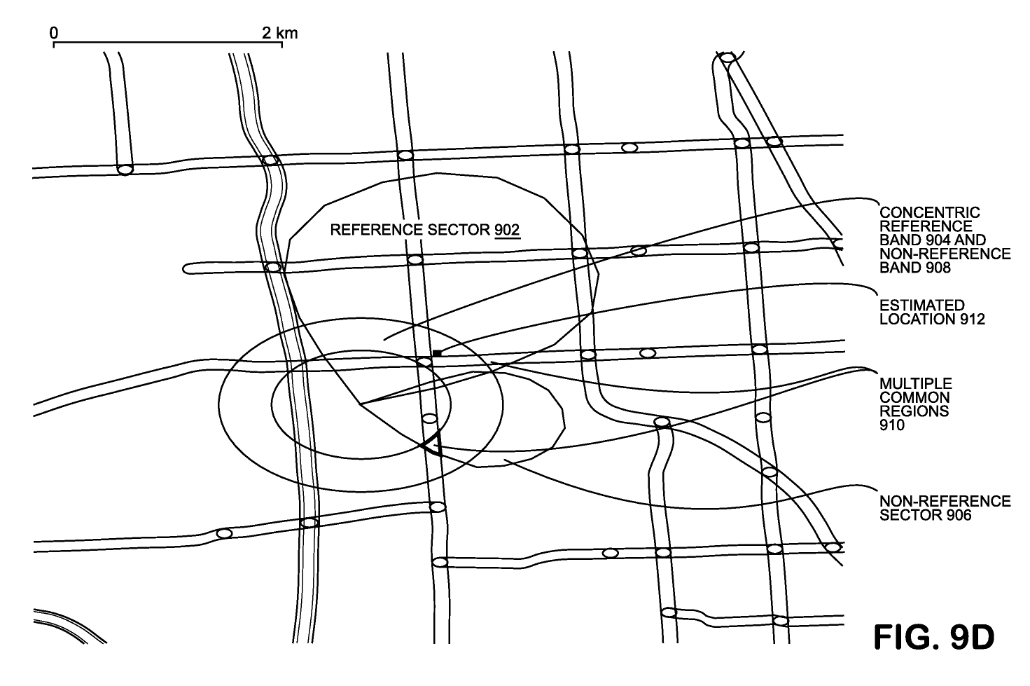

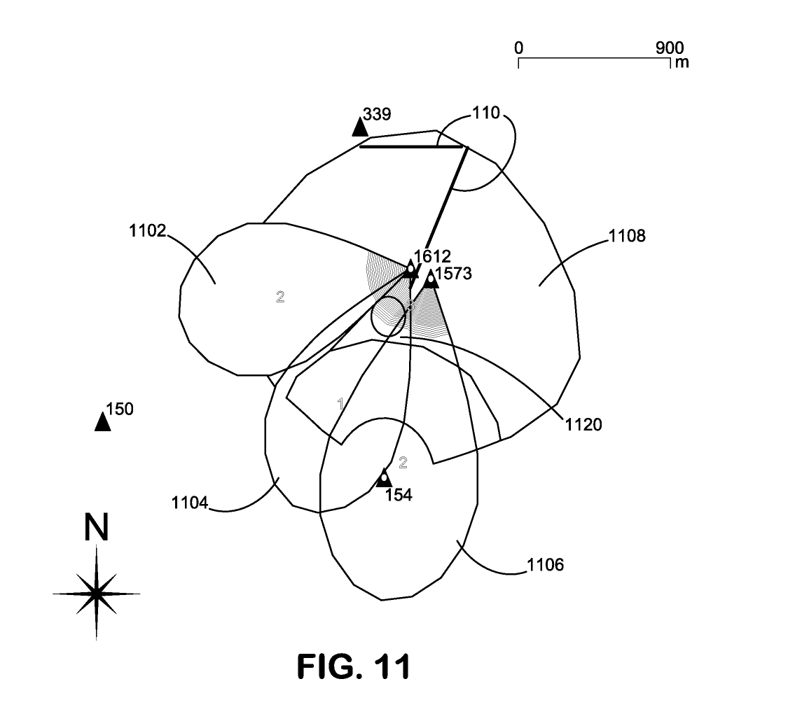

Technology for mobile device location estimation using operational data will now be described in greater detail with reference to FIGS. 1-13, which describe representative embodiments of the present invention. In the following description, for purposes of explanation, numerous specific details are set forth in order to provide a thorough understanding of the various embodiments. FIG. 1 describes an operational environment of a position determination engine configured to estimate location. the consolidated partnership valuation system. FIGS. 2-3 describe the position determination engine in greater detail. FIGS. 3-8, and 10 describe the different operations of the position determination engine to estimate location based on operational data using suitable illustrations and flowcharts. FIG. 9 provides a graphical illustration of location estimation using operational data. Further, FIGS. 11-13 provide a graphical illustration of location estimation using operational data and venue geometries. In addition, FIGS. 4-13 will be discussed, making exemplary reference back to FIGS. 1-3 as may be appropriate or helpful.

As described above, the present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

FIG. 1 illustrates an operating environment for the position determination engine, according to certain exemplary embodiments of the present invention. In particular, FIG. 1 illustrates a position determination engine 100, a mobile device 105, cellular tower 110, a base transceiver station 115, a base station controller 120, a mobile switching center 125, a home location register 130, a visitor location register 140, a public service telephone network 145, and an input output gateway 150.

The mobile device (MD) 105 transmits signals to and receives signals from the radiofrequency cellular tower 110 (e.g., transmission tower), while within a geographic cell covered by the cellular tower 110. These cells can vary in size based on anticipated signal volume. The cellular tower 110 may include one or more antennas that facilitate communication within the cell. In one embodiment, the cellular tower 110 may use an omnidirectional antenna or multiple directional antennas to handle communication within the cell. For example, a cellular tower 110 may have 3 directional antennas that cover 120 degrees each and thereby facilitating communication in 360 degree coverage area. The coverage area of an antenna may be referred to as a sector.

The base transceiver station (BTS) 115 facilitates providing service to mobile subscribers within a cell. Several BTS'S are combined and controlled by the base station controller (BSC) 120 through a connection called the Abis interface. The position determination engine 100 can interface with the Abis interface line as illustrated in FIG. 1. A Mobile Switching Center (MSC) 125 facilitates coordinating multiple BSC's, through the A Interface connection, keeping track of all active mobile subscribers using the Visitor Location Register (VLR) 140, maintaining the home subscriber records using the Home Location Register (HLR) 130, and connecting the mobile subscribers to the Public Service Telephone Network (PSTN) 145. The Input Output Gateway (IOG) 150 processes call detail records (CDRs) to facilitate such actions as mobile subscriber billing. The IOG 150 receives call-related data from the MSC 125 and can interface with the position determination engine 100.

The position determination engine 100 may monitor operational (e.g., signaling) data in the wireless network either directly or using a signal monitoring system such as a protocol analyzer. Alternatively, these messages may be extracted from a Base Station Manager that continuously monitors message streams on the BTS 115. In one embodiment, during communication, multiple antennas from one or more cellular towers may be communicably visible to and/or may service the mobile device 105. However, at any given time, one antenna of the multiple antennas visible to the mobile device, handles communication (e.g., holds the call) associated with the mobile device. The antenna that handles the communication is referred to as ‘reference antenna’ herein. At a given time, the other visible antennas that are not the reference antenna, may be referred to as non-reference antennas. For any given reason, if the reference antenna is not able to handle the communication associated with the mobile device, then the communication may be handed over to one of the non-reference antennas. At this time, the non-reference antenna to which the communication was handed over may become the new reference antenna. Further, the reference antenna that handed over the communication may become the new non-reference antenna, if the said antenna is communicably visible to the mobile device 105. The reference and non-reference antennas associated with the mobile device may be updated based on a location of the mobile device 105 and network traffic at a given time.

In an exemplary embodiment, the position determination engine 100 may receive operational data from various elements in the wireless network, and process the operational data along with other attributes to generate a location estimation for the mobile device 105. These elements may include the BSC 120, Abis interface, the BTS 115, MSC 125, and/or the HLR 130. In one embodiment, the position determination engine 100 may be implemented using one or more servers. Further, each module of the position determination engine may be implemented by one or more servers as well. In an example embodiment, the position determination engine may include a memory and a processor. In one example embodiment, the memory may be a non-transitory memory. Whereas, in another embodiment, the memory may be transitory memory or a combination of transitory and non-transitory memory. Further, the memory may be configured to store a set of instructions, which are executed by a processor to generate a location estimate of the mobile device based on operational data from a wireless network. The set of instructions may be associated with the operation of each module of the position determination engine 100. The position determination engine is further described below in greater detail in association with FIG. 2.

Turning to FIG. 2, FIG. 2 illustrates a block diagram of the position determination engine of FIG. 1, according to certain exemplary embodiments of the present invention. In particular, FIG. 2 illustrates a cellular network 202 otherwise referred to as a wireless network, a data extraction module 204, a modeling module 206, a parser module 208, a location module 210 and end users 212. Even though the term wireless network specifically refers to a cellular network in the following description, one skilled in the art could appreciate and understand that cellular network may be replaced by any appropriate wireless voice and/or data network, such as WLAN, WMAN, or WPAN.

The wireless network 202 can exchange information with the data extraction (DEX) module 204 of the position determination engine 100. Further, the DEX module 204 can exchange information with the parser module 208. The parser module 208 is configured to exchange information with the modeling module 206 and/or the location module 210. The modeling module 206 can exchange information with the location module 210, which in turn can exchange information with end users 212.

In one embodiment, the DEX module 204 can directly exchange information with the modeling module 206 and/or the end users 212. In one embodiment, the modeling module can exchange information with the end users 212. In some embodiments, a process other than DEX module 204 may provide operational data to the parser module 208, modeling module 206 and/or the location module 210. The end users 212 may include information service providers, location based service providers, a government organization, law enforcement agencies, emergency service providers, transportation providers or media outlets. The type of information exchanged between the modules is described below in association with FIG. 3.

Turning to FIG. 3, FIG. 3 illustrates an overview of the position determination engine process, according to certain exemplary embodiments of the present invention. In operation 366, the modeling module 206 may receive geospatial feature data 354 associated with a region of the wireless network 202. The geospatial feature data can include both information regarding roads and also venues within a geographic area of interest. As described above venues may include different points of interest. Even though geospatial features are specifically referred to as roads and venues in this description, one of ordinary skill in the art could appreciate and understand that roads may be replaced by lakes, railroads, hallways, pedestrian walkways or any such appropriate feature. In one example embodiment, the geospatial feature data 354 may be obtained from a government organization, transportation department and/or a commercial vendor. In another example embodiment, the geospatial feature data 354 may be received as a map from a third party map source such as Google maps, MapQuest, Waze, etc. The geospatial feature data 354 may represent the geospatial feature in the form of lines or dots. For example, the roads may be represented as lines and venues as dots. In operation 366, the modeling module 206 may create a polygon that bounds the line representing the geospatial feature (e.g., road, venues). The dimension of the polygon that bounds the geospatial feature may be user settable. In an example embodiment, the area bound by the polygon may correspond to a scaled version of the geospatial feature in the real world.

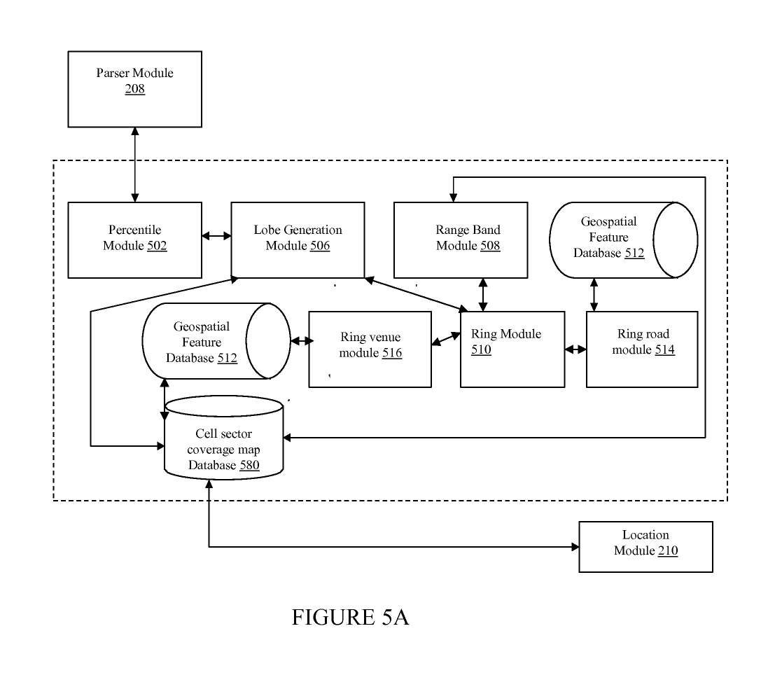

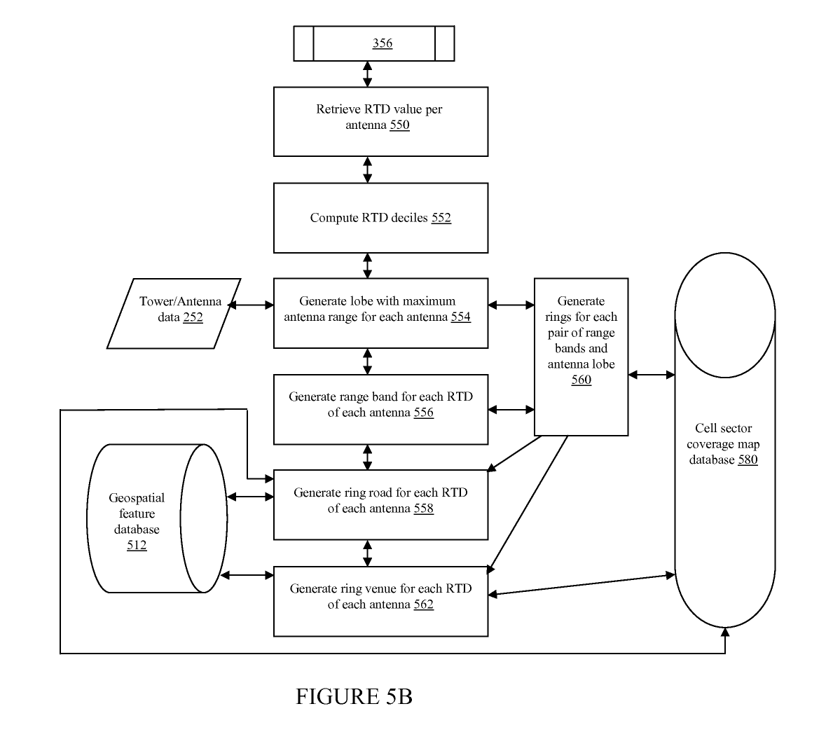

In operation 368, the modeling module 206 may receive the polygon geometry representative of the geospatial feature and create a geospatial model of the geospatial feature comprising the representative polygons bounding geospatial features. The geospatial model of the geospatial feature (hereinafter road and venue map) may be stored as road and venue database (shown in FIG. 5A as 512).

In one embodiment, the parser module 208 may receive the first operational data and/or second operational data from the DEX module 204. The DEX module 204 interacts with the wireless network 202 to retrieve operational data from the wireless network 202. In one embodiment, the DEX module 204 may be a software module coupled to any appropriate element of the wireless network 202 to retrieve operational data from the wireless network 202. In another embodiment, the DEX module may be a hardware device or a combination of software and hardware device coupled to any appropriate element of the wireless network 202. The DEX module 204 may stream data from the wireless network to the position determination engine 100. The streamed operational data may be stored in the position determination engine 100 or in a storage device external to the position determination engine 100.

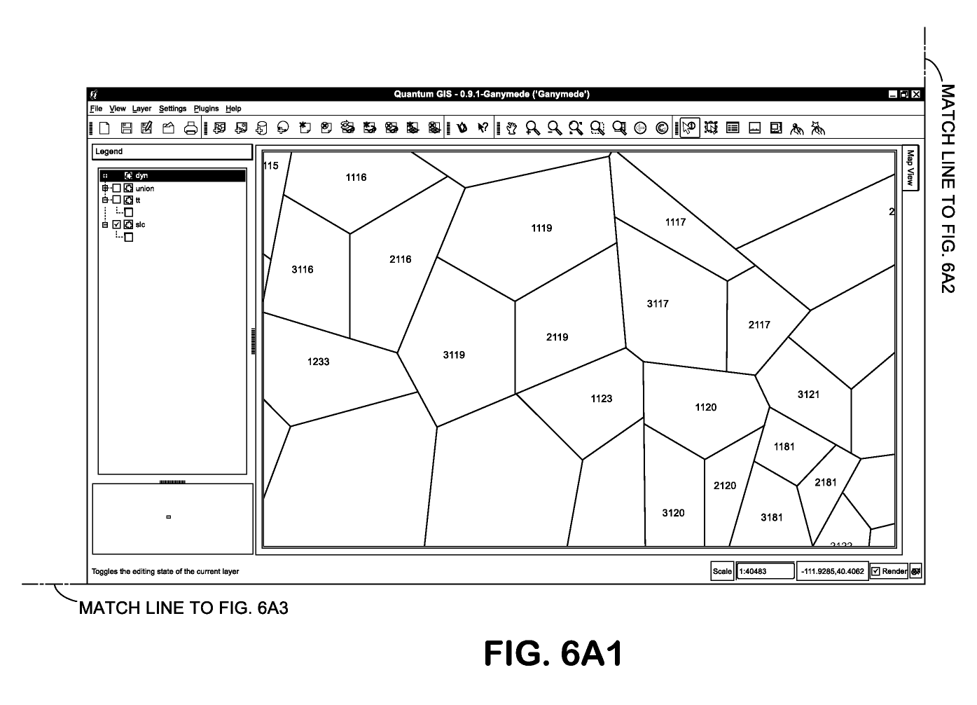

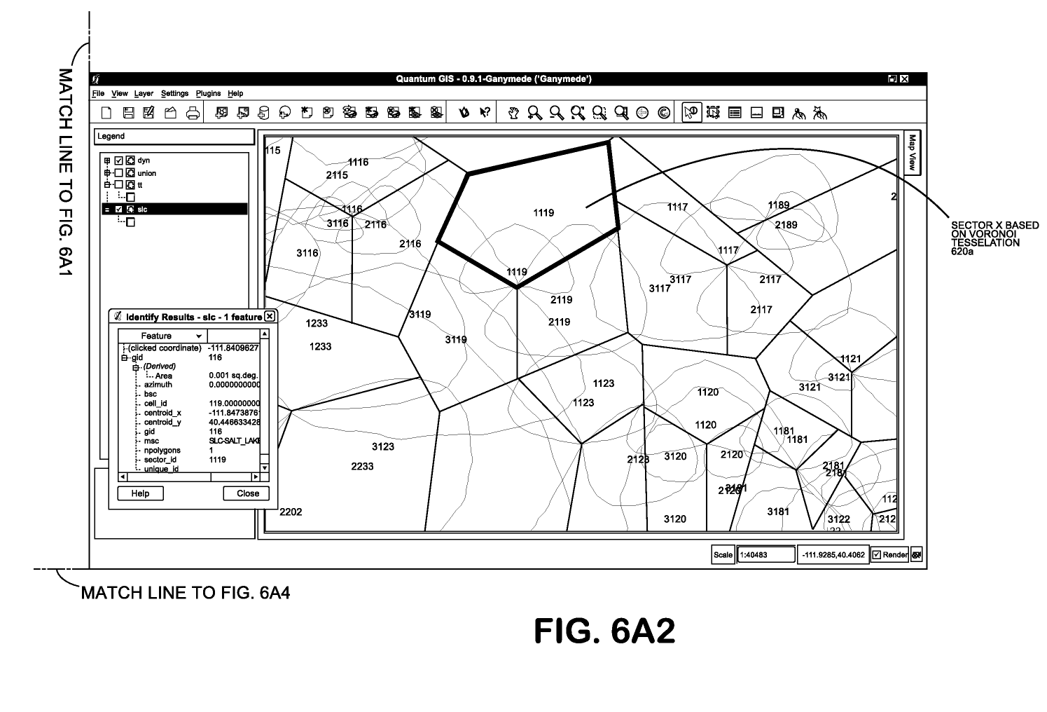

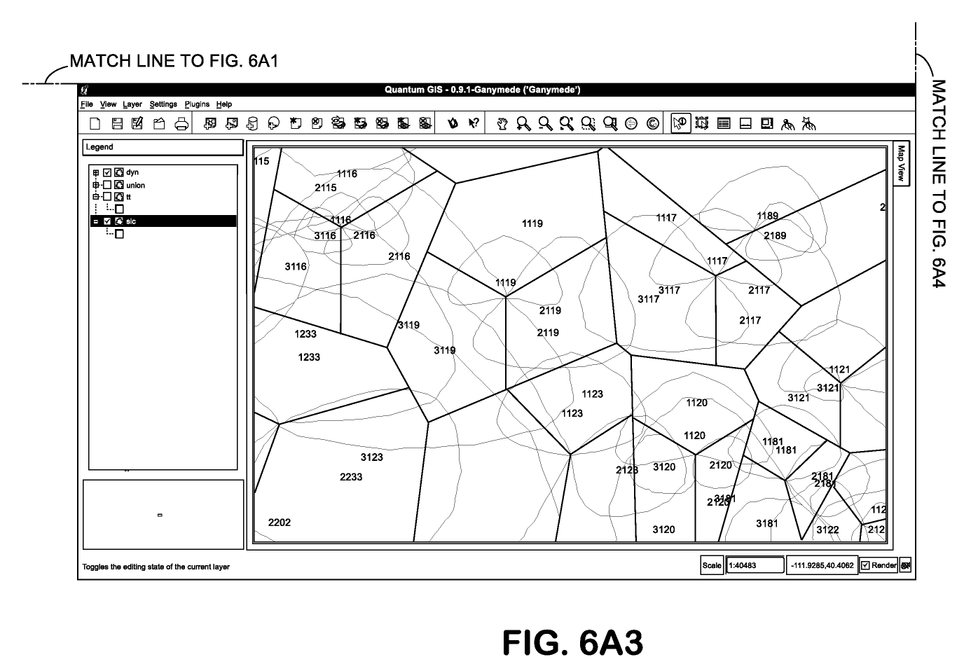

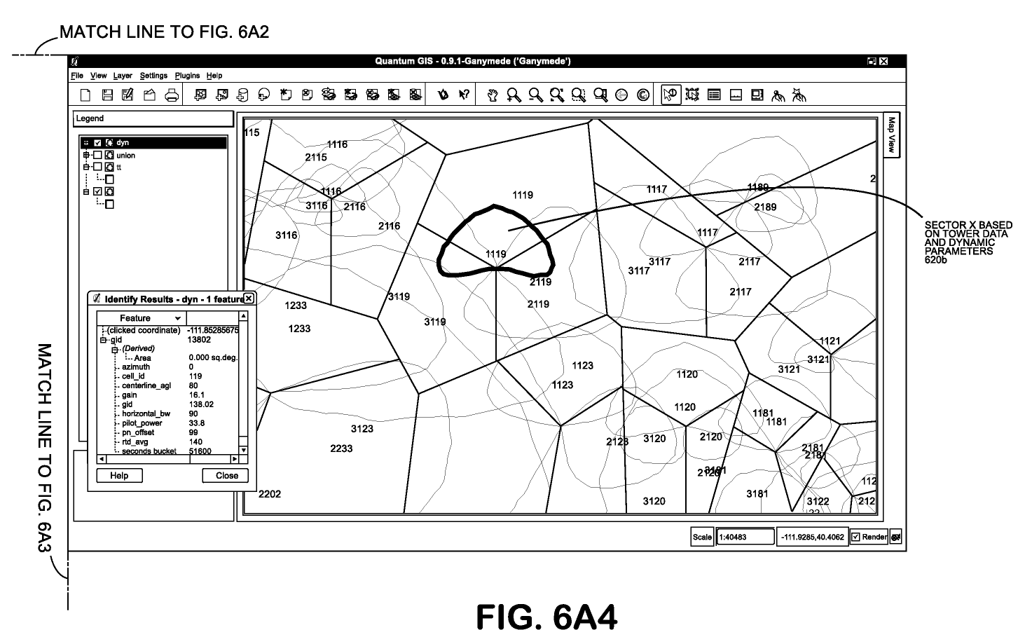

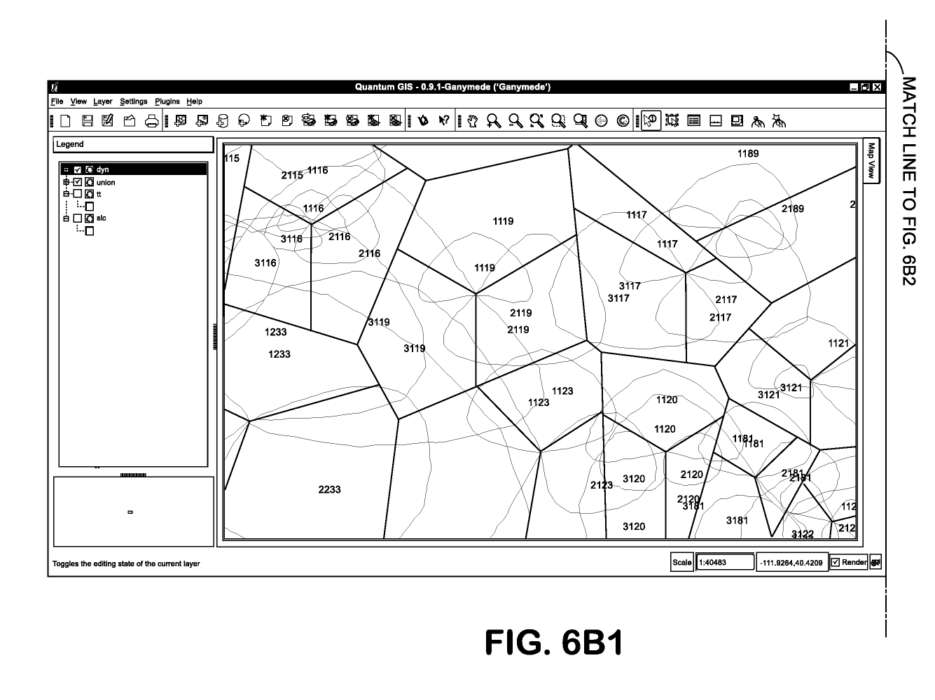

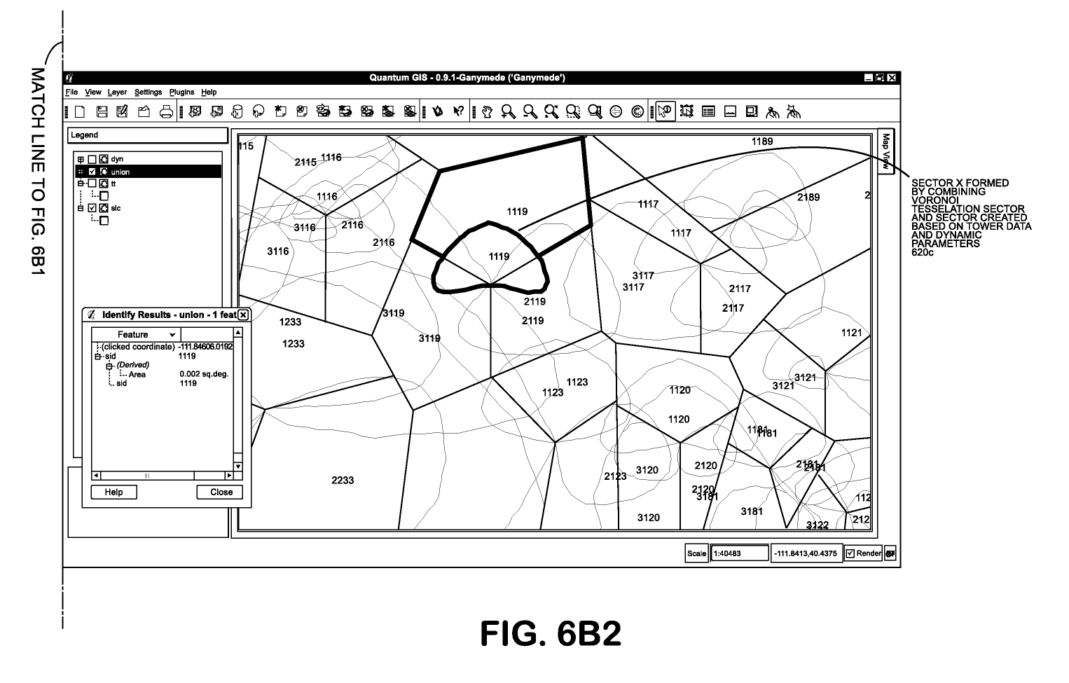

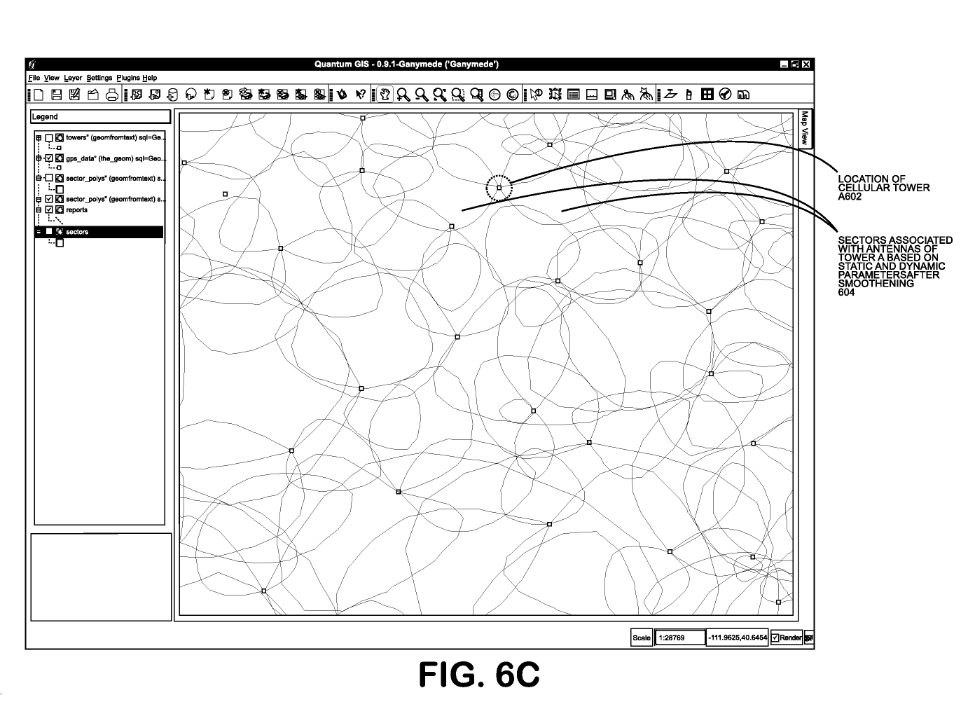

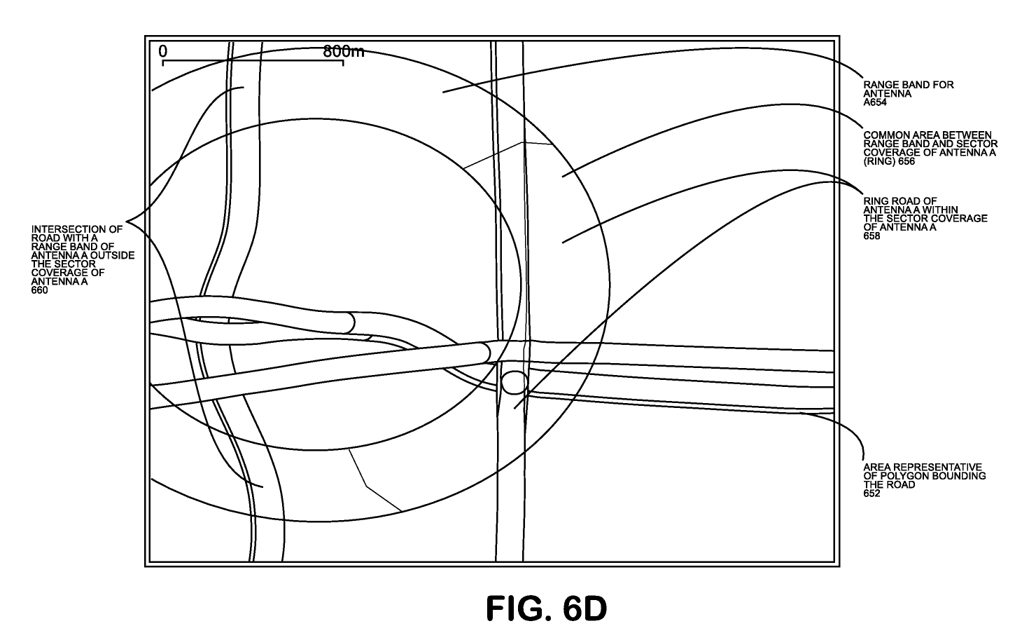

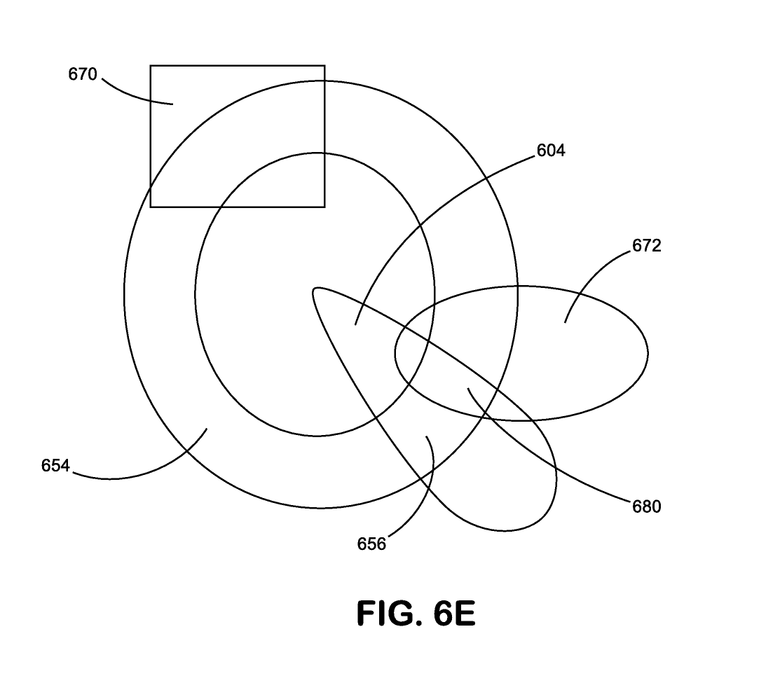

In one embodiment, the first operational data 350 may refer to operational data used to generate various geospatial models that are described in greater detail below and in association with FIGS. 5B-6D. The first operational data may be operational data collected from the wireless network 202 over a predetermined period of time. For example, first operational data used to generate the geospatial models may be collected for a 3-4 hour time interval. Further, the first operational data 350 may be collected during the course of or prior to generating the geospatial models. First operational data 350 may be produced by the wireless network 202 in the normal course of wireless network operation. The first operational data 350 streamed from DEX module 204 may include one or more signaling records.

Upon receiving the first operational data and/or second operational data from the DEX module 204, the parser module 208 may process the first operational data and/or the second operational data. Further, the parser module 208 can extract one or more signaling records from the operational data (first and/or second). Typical information contained in a signaling record may include at least the identity of one or multiple cell towers/antennas servicing a call, data indicating the elapsed time that signals take to travel the distance from the antenna to the mobile device (round-trip delay (RTD), and/or other measures related to distance from the antenna such as a measure of signal phase and/or signal strength. The parser module 208 may parse the signaling record to extract desired data such as the identity of one or multiple cell towers/antennas listed in the signaling record call, RTD, signal phase and/or signal strength associated with each antenna.

When multiple antennas are communicably visible to the mobile device 105, including the reference antenna that services the call and the non-references antennas, the parser module 208 can sort the multiple antennas in a specific order. The sorting mechanism may be described in greater detail, in association with FIG. 4B. More than one communicably visible antenna may facilitate a more accurate and likely location determination for the mobile device 105. As described above, each signaling record of the operational data, (first and/or second) may list information of any antenna that is communicably visible to (and/or services) the mobile device 105 along with the reference antenna that services the call.

Further describing the signaling record, each signaling record may be time stamped, which allows estimation of the location of the mobile device 105 at a particular point in time. The types and timing of the signaling record may differ based on the specific wireless network technology used by the carrier in an area. For some technologies, the types of signaling record that can be received and used in location estimation include call start, call completion, or call drop, as well as cell tower “handoff”. For other technologies, periodic transactions throughout the call may be recorded. As described above, signaling records may be generated at the beginning or a call, at the end of a call and/or periodically in between calls based on the wireless network technology.

Signaling data may be produced for voice calls, text messages, and/or any appropriate data connections. In an example embodiment, signaling data may be a subset of an operational data. The operational data can be thought of as a “picture” of one or more cell towers/antennas, the mobile device could “see” at the time of the generating or logging the signaling record.

In one embodiment, the signaling data may include RTD values for the reference antenna, but the signaling data may not include the RTD value for the non-reference antennas. Instead, the signaling data may include a trip delay for the non-reference antennas. The trip delay may generally refer to time taken for a signal or a data packet to be travel from the reference antenna to the mobile device and from the mobile device to the non-reference antenna.

Upon receiving the trip delay for each non-reference antenna, the position determination engine 100 may calculate the round trip delay time (RTD) for each of non-reference antennas using the trip delay value of the respective non-reference antenna, and the RTD value of the reference antenna.

In operation 356, using the first operational data, the modeling module 206 may generate a wireless network sector coverage map database (cell sector database hereinafter) (shown in FIG. 5A as 580). In one embodiment, the road and venue database 512 may be a part of the cell sector database 580. The process of creating the cell sector database 580 may include receiving, from the parsing module 208, the parsed data comprising the identity of the antennas, RTD values and/or other appropriate values associated with the antennas in the wireless network 202. In addition, the modeling module 206 may receive tower/antenna data 352 from the wireless network carrier. Tower/Antenna data 352 may be produced and maintained by a carrier and made available to the position determination engine 100. Tower/Antenna data 352 may include the geographic position of the tower (latitude/longitude), a unique identifier for the tower/antenna, the number of antennas on the tower and the specific direction from which they will receive/transmit (the azimuth), as well as a measure of horizontal beam width coverage.

Using the tower/antenna data 352 and the parsed data associated with historical operational data (first operational data), the modeling module 206 may generate a geospatial model representative of the wireless network coverage. The geospatial model representative of the wireless network coverage may include locations of one or more antennas in the wireless network 202. Further, the geospatial model representative of the wireless network coverage (hereinafter network map) may include geometries defining the coverage areas of each antenna (sectors) of the one or more antenna in the wireless network 202. In one embodiment, calculations of the network map can be performed as often as desired to keep the model updated for changes in the cellular network. For example, the network map may be created every time a carrier adds a tower in the cellular network or when a tower is removed from the cellular network. In an additional embodiment, the calculations of the network map may include changing atmospheric conditions.

Further, in operation 356, the road and venue map created in operation 368 may be stored in the cell sector database and incorporated into (or overlaid on) the network map to create the cell sector database. The process of creating the network map and the cell sector database 580 (in operation 356) is described in greater detail in association with FIGS. 5B-6D. The road and venue map and cell sector database may be preprocessed. In one embodiment, the network map and the cell sector database may be created as an initial phase of location estimation process. In an alternate embodiment, the network map and/or the cell sector database 580 may be generated and made available to the position determination engine 100 by a commercial vendor or the cellular network carrier.

Once the cell sector database is generated, the position determination engine 100 may be configured to extract the second operational data. The second operational data 360 may refer to operational data used to calculate location of the mobile device in the wireless network 202. Once geospatial models are generated using the first operational data, the second operational data may be collected in near real-time during the course of estimating the location of the mobile device 105. In some embodiments, the second operational data 360 may be collected prior to estimating the location of the mobile device 105. In an alternate embodiment, the first operational data 350 may be used to estimate location of the mobile device. Hereinafter, the first operational data may be referred to as historical operational data and the second operational data may be referred to as real-time operational data.

In operation 370, using the real-time operational data associated with the mobile device 105 of interest and the cell sector database 580, the location module 210 may estimate the location of the mobile device 105 in the wireless network 202. In another embodiment, the location of the mobile device 105 may be estimated based on the road and venue map, the network map and other features such as range bands associated with the network map. Range bands are described in detail below, in associated with FIGS. 5A-5B.

In operation 372, the location module 210 may grade an accuracy of the estimated location based on a quality and/or a quantity of elements used to estimate the location. For example, an accuracy of a location estimated based on one antenna may be graded lower than the accuracy of a location estimated using more than one antenna.

In addition to grading an accuracy, the location module 210 may generate an error radius for each estimated location to qualify the estimated location. The error radius may be defined as the maximum distance of the estimated location from the actual location with an X % confidence. In an example embodiment X % may be 90%. For example, an error radius of 100 meters associated with an estimated location Y suggests that there is a X % percent probability that the distance between the estimated location Y and the actual location of the mobile device is less than 100 meters.

The overall process of the position determination engine 100 based on operational data and road maps may be described in greater detail in the following paragraphs, in association with FIGS. 4A-9D.

Turning to FIG. 4A, FIG. 4A illustrates a block diagram of the parser module of the position determination engine, according to certain exemplary embodiments of the present invention. In particular, FIG. 4A illustrates a DEX module 204, an antenna data extraction module 402, an antenna sort module 404, an antenna list module 406, the modeling module 206, and the location module 210.

The DEX module 204 can exchange information with the antenna data extraction module 402. The antenna data extraction module 402 can exchange information with the modeling module 206 and/or the antenna sort module 404. Further, the antenna sort module 404 may exchange information with antenna list module 406, which in turn exchanges information with the location module 210. In some embodiments, the antenna list module 404 may exchange information with the modeling module 206. In an alternate embodiment, operations of the antenna data extraction module 402, the antenna sort module 404 and/or the antenna list module 406 may be performed using any one of the above mentioned modules 402-406. The information exchanged between modules and the operation of the parser module is described in further detail in associated with FIG. 4B.

Turning to FIG. 4B, FIG. 4B illustrates a process of the parser module, according to certain exemplary embodiments of the present invention. In operation 450, the DEX module 204 may stream operational data (historical operational data and/or real-time operational data) to the antenna data extraction module 402 of the parser module 208.

In operation 452, the antenna data extraction module 402 can process the operational data to extract signaling records. Further, the antenna data extraction module 402 can parse the signaling records to extract desired antenna data. When the historical operational data is parsed, the extracted data is sent to the modeling module 206 to facilitate creating the cell sector database 580 and/or the network map. Whereas, when the real-time operational data is parsed, the extracted data is sent to the antenna sort module 404. In operation 456, for each signaling record, the antenna sort module 404 may identify one or more antennas communicably visible to (and/or servicing) the mobile device 105. The antennas communicably visible to the mobile device may include a reference antenna and one or more non-reference antennas. In some embodiments, the signaling records may identify a reference antenna, i.e., no additional operations may need to be performed to determine the reference antenna. Further, any antenna that is not identified as the reference antenna may be categorized as the non-reference antenna. In some embodiments, the signaling record may include a reference antenna and no non-reference antenna. In another embodiment, the signaling record may include a reference antenna and a non-reference antenna. In yet another embodiment, the signaling record may include the reference antenna and one or more non-reference antennas.

In operation 456, the antenna sort module 404 may sort the one or more non-reference antennas based on one or more antenna data such as RTD and/or signal strength. In an exemplary embodiment, the one or more non-reference antennas may be sorted based on RTD values associated with the antennas. Once the non-reference antennas are sorted based on the RTD values and if two or more non-references antennas have substantially similar RTD values, then the first sorted list of non-reference antennas is further sorted based on signal strength values of each of the non-reference antennas. Based on RTD value, the antennas may be sorted as antennas in the signaling record having lowest RTD value to antennas having highest RTD value, with antenna having lowest RTD value as preferred antenna. Based on signal strength, the antennas may be sorted as antennas in the signaling record having the highest signal strength to antennas having lowest signal strength, with the antenna having highest signal strength as the preferred antenna. In another embodiment, the one or more non-reference antennas may be sorted based on the signal strength alone.

In yet another embodiment, the one or more non-reference antennas may be sorted based on the signal strength. Once the non-reference antennas are sorted based on the signal strength and if two or more non-reference antennas have substantially similar signal strength values, then the first sorted list of non-reference antennas is further sorted based on RTD values of each non-reference antenna.

Further in operation 456, the sorted non-reference antennas along with the reference antenna are arranged as a list. Further, the list of sorted antennas communicably visible to the mobile device may be forwarded to the location module 210 to facilitate estimating a location of the mobile device. In the sorted list of antennas, the reference antenna may be the first listed antenna followed by the non-reference antennas in the sorted order.

In one embodiment, the signaling record may include multiple fields. One of the multiple fields may identify the antenna as a reference antenna. In an alternate embodiment, if the field that identifies the reference antenna is empty, the parser module 208 may sort all the antennas based on signal strength and/or RTD values. The first antenna (antenna with lowest RTD value or highest signal strength based on the sorting) in the sorted list may be identified as reference antenna. In another embodiment, if the field that identifies the reference antenna is empty, the parser module 208 may generate a corresponding error message, which may be transmitted to the end user, location module 210 and/or the modeling module 206. The modeling module 206 is described in greater detail in association with FIGS. 5A-5B.

In another exemplary embodiment, the parser module 208 may process the real-time operational data to extract the associated signaling record. The signaling record may include a number of antennas communicatively associated with (e.g., communicably visible or servicing) a mobile device of the signaling record. The number of antennas may be sorted based on RTD values. In one embodiment, the antenna with the smallest RTD may be set as the reference antenna (regardless of the reference identifier field) and the following antennas may be set as non-reference antenna.

In yet another exemplary embodiment, the parser module 208 may process the real-time operational data to extract the associated signaling record. The signaling record may include a number of antennas communicatively associated with (e.g., communicably visible or servicing) a mobile device of the signaling record. The number of antennas may be sorted based on signal strength values. In one embodiment, the antenna with the highest signal strength may be set as the reference antenna (regardless of the reference identifier field) and the following antennas may be set as non-reference antenna.

### Model Generation

Turning now to FIG. 5A, FIG. 5A illustrates a block diagram of the modeling module of the position determination engine, according to certain exemplary embodiments of the present invention. In particular, FIG. 5A illustrates a parser module 208, a percentile module 502, a lobe generation module 506, a range band module 508, a ring module 510, a ring road module 514, a ring venue module 516, a geospatial feature database 512 and a location module 210.

The parser module 208 may exchange information with the percentile module, which in turn may exchange information with the lobe generation module 506. Further, the parser module 208 may exchange information with the range band module 508. In an alternate embodiment, the percentile module 502 and/or range band module 508 may directly communicate with the DEX module 206, if the data received from the DEX module is pre-processed to extract desired antenna data.

The lobe generation module 506 and the range band module may exchange information with the ring module 510. Further, the ring module may exchange information with the ring road module 514 and the ring venue module 516. The ring road module 514 may be coupled to the road and venue database 512 (interchangeably referred to as ‘geospatial feature database’ herein), with which information may be exchanged. The range band module 508, the lobe generation module 506, the ring module 510, ring venue module 516, and the ring road module 514 may be logically coupled to the cell sector database 580. In one embodiment, information may be exchanged between the cell sector database 580 and range band module 508, the lobe generation module 506, the ring module 510, ring venue module 516, and the ring road module 514. The operation of the modeling module and the information exchanged is described in further detail, in association with FIG. 5B.

Turning to FIG. 5B, FIG. 5B illustrates a process of the modeling module for creating geospatial models and associated cellular network sector database, according to certain exemplary embodiments of the present invention. Even though some of the following description may refer to calculations from the perspective of one antenna in the wireless network, one of ordinary skill in the art could appreciate and understand that the modeling module 206 can handle calculations for numerous antennas in parallel or sequentially.

In operation 550, the percentile module 502 may receive a number of RTD values associated with signaling records of historical operational data collected over a predetermined period of time. In some embodiments, the percentile module 502 may receive other values such as signal strength and/or signal phase.

In one embodiment, the RTD values may be received from the parser module 208. In another embodiment, the RTD values may be directly received from the DEX module 204 provided the DEX module 204 is configured to extract RTD values. In operation 552, the percentile module 502 may process a number of RTD values, associated with an antenna, to generate RTD deciles. In an alternate embodiment, the received RTD values may be distributed into an ‘x’ number of groups. Further, in operation 552, the percentile module 502 may determine a characteristic RTD value based on the RTD deciles. The characteristic RTD value may be determined such that a given percentage of the number of received RTD values of the antenna fall below the characteristic RTD value. For example, the 80^{th} percentile RTD value may be chosen as characteristic RTD. The characteristic RTD value having an 80^{th} percentile RTD value suggests that 80% of the received RTD values fall below the characteristic RTD value.

In operation 554, using the characteristic RTD value and static parameters such as the tower/antenna data 252 (and/or Voronoi generated sectors), the lobe generation module 506 may generate a geometry representative of coverage area of the antenna. The geometry of the antenna coverage area may represent at least a maximum effective range of the antenna that is calculated based on the characteristic RTD. The maximum effective range may refer to the maximum distance from the antenna that pilot information from the antenna may be received. In an example embodiment, the geometry of the antenna coverage area may represent the location of the antenna in the cellular network, the direction of orientation of the antenna and/or the spread of the signal beam associated with the antenna, which may be calculated based on the static tower/antenna data 252. The tower/antenna data 252 may be incorporated with the characteristic RTD (which is a dynamic parameter) to enhance the geometry of the antenna coverage to substantially accurately represent the coverage of the antenna is the real world.

Creating the geometry representative of the antenna coverage area may include creating a “bounding polygon” (typically looking like a kite with the antenna at the bottom of the kite pointed at the top and the “top” point of the kite defined by the maximum calculated effective range of the antenna). In some embodiments, the maximum calculated effective range of the antenna may be determined based on other parameters associated with the historical operational data such as signal phase and/or signal strength. In an alternate embodiment, the maximum calculated effective range of the antenna may be determined based on static parameters. Further, the “width” of the polygon (e.g., kite shape) may be determined by the published beam width of the antenna obtained from the tower/antenna data 252 (and/or Voronoi generated sectors). The overall shape may be governed by ratios that were derived to best mimic the off axis attenuation that directional antennas exhibit. Once the bounding polygon is calculated, an appropriate smoothening function may be applied to approximate and smoothen the boundaries of the sector within the bounding polygon. The output of the function may be a lobe-shaped sector approximation that incorporates the dynamic parameter from historical operational data, along with the published identification, location, azimuth, and beam width of the antenna from the tower/antenna data 252. The geometry representative of the antenna coverage area (hereinafter sector geometry) may be stored in the cell sector database 580.

In another embodiment, the tower data received from the wireless network provider may include a maximum antenna range value provided by the wireless network operator (e.g., carrier). Further, the modeling module 206 may generate a sector geometry based on the maximum antenna range value. In yet another embodiment, the modeling module 206 may generate the sector geometry for an antenna based on the combination of the maximum antenna range value from the tower data and the RTD values from the historical operational data (e.g., using characteristic RTD value as described above). The creation of the sector geometry may be graphically presented in FIGS. 6A-6C.

Turning now to FIGS. 6A-6C, FIGS. 6A-6C present a graphical representation of the process of generating geospatial model of cellular network coverage, according to certain exemplary embodiments of the present invention. In particular, FIG. 6A illustrates geometry of Voronoi generated sector (sector X) 620a. Further, FIG. 6A illustrates geometry of the sector X generated by static parameters (e.g., tower data) and dynamic parameters (e.g., RTD, signal strength, signal phase, etc.) 620b.

FIG. 6B illustrates a hybrid approach that generates geometry of sector X 620c by combining the geometry of sector X 620a obtained from Voronoi tessellation and the geometry of sector X 620b obtained from static and dynamic parameters. FIG. 6C illustrates a network map including sector geometries after the sectors are smoothened. In particular, FIG. 6C illustrates the location of a cellular tower A 602 and the sectors geometries 604 associated with the antennas of cellular tower A.

Returning to FIG. 5B, in operation 556, the range band module 508 may receive a number of RTD values from signaling records associated with historical operational data. Each signaling record may include RTD values from one or more antennas in the cellular network. In operation 556, the range band module 508 may convert the RTD value to a corresponding distance. Further, based on the RTD value, the range band module 508 may create a geometry representative of a distance band having a first (e.g., upper bound) distance boundary and a second (e.g., lower bound) distance boundary from the antenna. RTD may be reported as a measure of time called “chips” that is set such that one “chip” is equivalent to x meters of distance (e.g., 15 meters of distance). In an exemplary interpretation of RTD, a reading of 100 chips would put the mobile device 1500 meters from the location of the antenna. In the real world, however, this value may not be perfectly accurate, so the range band module may apply mathematical functions that may fit the received RTD value to a historically observed error in the RTD value. These functions may return a first and second distance for the estimated distance (RTD based distance) based on the historically observed error. The resulting region may be a “band” of potential locations around the antenna that comprises the reported distance corresponding to the RTD value including the expected distance error value.

Each antenna may have a number of range bands associated with it, based on the number of RTD values of the antenna. For example, an antenna in the cellular network may have 1000 range bands associated with each antenna. Range band 100 may extend from 1000 meters (e.g., first distance) to 1020 meters (e.g., second distance) which may correspond to RTD values 100 to 120. Thus range band 100 may represent any RTD values that fall between 100 and 120. RTD values that fall outside 100 to 120 value range may fall in another range band associated with the antenna.

Further, in operation 560, the ring module 510 may mathematically or logically intersect (or overlay) each range band of the antenna with the sector geometry of the antenna which may result in a new geometry that represents an area common to the range band and the sector geometry, referred to as a ring. In one embodiment, for each antenna, there may be as many number of rings as the number of range bands associated with the antenna. The ring may be portion or subset of the range band. In one embodiment, if a range band lies outside the sector geometry, then the range band may not have a ring since the range band does not intersect the sector geometry. The calculated range band values (and/or geometry) and the ring geometries may be stored in the cell sector database 580.

In operation 558, the ring road module 514 may retrieve the road and venue map from the geospatial feature database 512. In one embodiment, the geospatial feature database 512 may be a part of the cell sector database 580. Further, in operation 558, the ring road module 514 may mathematically or logically intersect the road and venue map with each ring of the antenna. The geometry resulting from the intersection of the road geometry and the ring, if any, may be stored in the cell sector database 580 as ring roads.

In operation 562, the ring venue module 516 may retrieve the road and venue map from the geospatial feature database 512. Further, the ring venue module 516 may mathematically or logically intersect the road and venue map (geospatial model of geospatial features) with each ring of the antenna. The geometry resulting from the intersection of the venue geometry associated with the road and venue map and the ring, if any, may be stored in the cell sector database 580 as ring venues. Using the modeling module, venue geometries that fall within a threshold RTD value associated with an antenna may be listed as venues serviced by the antenna based on the first operational data 350. Further, the modeling module 206 may generate a list of the antennas that service a venue. In one embodiment, the list of antennas servicing a venue may be determined based on RTD values. In some embodiments, other parameters such as signal strength, or distance from venue can be used to determine the antennas that service the venue.

The foregoing operations described in association with FIG. 5B, may refer to calculations for one antenna. To create a network map and/or cell sector database for the cellular network, the said operations may be repeated (sequentially or in parallel) for each tower/antenna in the cellular network.

The cell sector database 580 may refer to a collection of data including data representing sector geometry for each antenna in the cellular network, range band geometry for each antenna in the cellular network, ring geometry of each range band for each antenna in the cellular network, ring road geometry of each ring for each antenna in the cellular network, ring venue geometry of each ring for each antenna in the cellular network, list of antennas that service a venue, and/or the road and venue map. Using an appropriate API, the database 580 may be accessed to retrieve the data. In an example embodiment, the position determination engine 100 may be configured to visually represent (e.g., as a map) as illustrated in FIG. 6D.

Turning to FIG. 6D, FIG. 6D presents a graphical representation of overlay of cell sector coverage map database elements excluding the ring venue geometry, according to certain exemplary embodiments of the present invention. FIG. 6D illustrates cell sector database elements associated with an example antenna A. Antenna A may have a number of range bands and one of the range band 654 is illustrated in the exemplary embodiment of FIG. 6D. Further, the exemplary embodiment of FIG. 6D illustrates the ring 656 representative of an area of intersection between the range band 654 and the sector geometry of antenna A (not shown in the Figure). The area of intersection between the ring 656 and the road geometry 652 is represented as ring road 658. FIG. 6D also illustrates an area of intersection 660 of the road geometry with the range band 654 outside the ring 656. Similarly, FIG. 6E illustrates a ring venue geometry.

Turning to FIG. 6E, FIG. 6E presents a graphical representation of overlay of cell sector coverage map database elements including the ring venue geometry, according to certain exemplary embodiments of the present invention. In particular, FIG. 6E illustrates a venue geometry 1 670, a venue geometry 2 672, the range band/reference band 654, the ring geometry 656, the sector geometry 604, and the ring venue geometry 680. In an example embodiment, the area of intersection between ring geometry 656 and the venue geometry 2 672 is represented as ring venue geometry 680.

Referring back to FIG. 5B, In one embodiment, the cell sector database 580 may be preprocessed prior to estimating the location of a mobile device in the wireless network 202. In another embodiment, the cell sector database 580 may be created as an initial phase of the location estimation process. Using the data in the cell sector database 580, the location module 210 may estimate the location of a mobile device 105 in the wireless network 202 based on real-time operational data. In one embodiment, the real-time operational data may be streamed by the DEX module 204 once the cell sector database 580 is created.

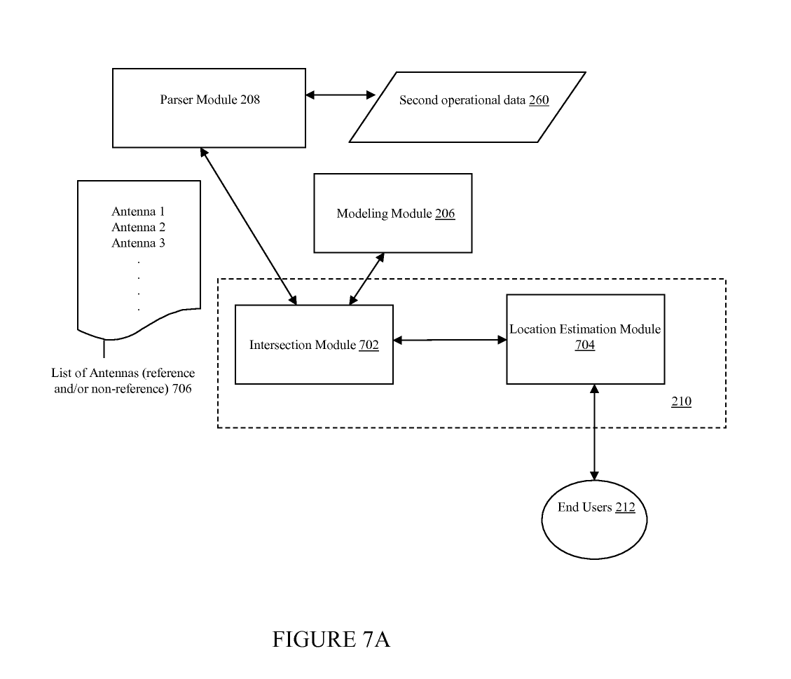

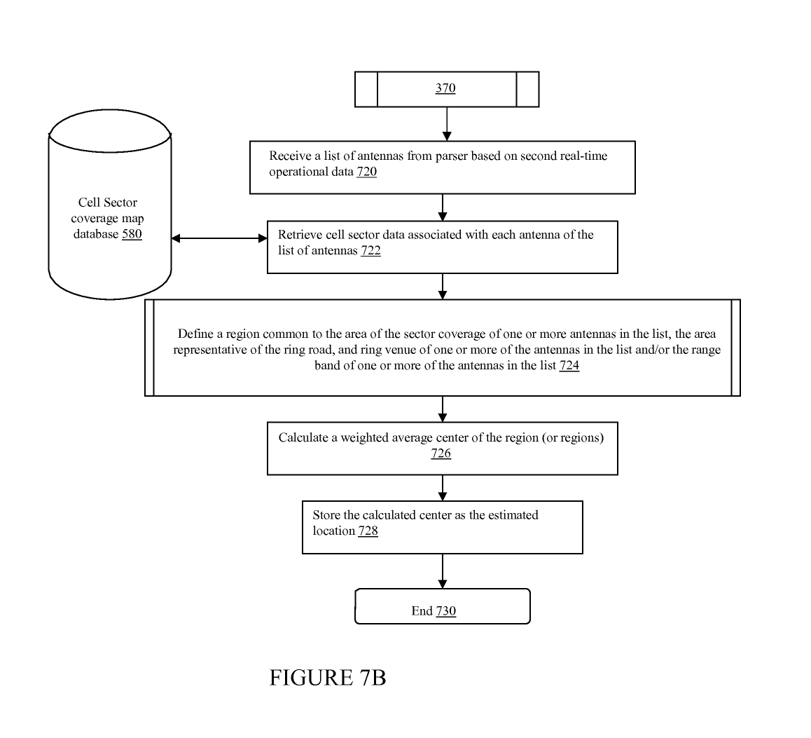

In one embodiment, the cell sector database may only include data representative of the sector geometry for each antenna in the cellular network and road and venue map. In the said embodiment, the ring geometry of each range band for each antenna in the cellular network and ring road geometry of each ring for each antenna in the cellular network, and the ring venues may be created by the location module 210. The location module 210 may be described in greater detail in association with FIG. 7A.

### Location Estimation

In one embodiment, a location of a mobile device 105 in the wireless network 202 may be estimated, by the location module 210, based on real-time operational data received (e.g., streamed by DEX module 204) from the cellular network. The real-time operational data may include a number of signal records. Each signal record may be associated with the communication of a mobile device in the cellular network and the one or more antennas assisting the communication.

In one embodiment, the location of the mobile device 105 may be automatically estimated for each signaling record. In another embodiment, the location of the mobile device 105 may be estimated upon request. All the estimated locations for the mobile device 105 may be stored in a location database and the location may be retrieved by an end user 212 through accessing the database. Alternately, the location may be presented to the end user 212 by the position determination engine 100 upon request. Further, for each estimated location, the location module 210 may generate an error ring to qualify the estimated location.

Turning to FIG. 7A, FIG. 7A illustrates a block diagram of the location module of the position determination engine, according to certain exemplary embodiments of the present invention. In particular, FIG. 7A illustrates the parser module 208, the real-time operational data otherwise referred to as second operational data 260, a list of antenna document 706, the modeling module 206, an intersection module 702, a location module 704 and the end users 212. The parser module 208 may exchange information with the DEX module 204. In addition, the parser module 208 may exchange information (e.g., list of antennas 706) with the intersection module 702. In an alternate embodiment, the intersection module 702 may receive real-time operational data directly from the DEX module 204. Further, the modeling module 206 may exchange information with the intersection module 702, which in turn exchanges information with the location module 704. The location module 704 may exchange information with end users 212. The operation of the location module 210 and the information exchanged between the modules is discussed in greater detail in association with FIG. 7B.

Turning to FIG. 7B, FIG. 7B illustrates a process of the location module for location estimation, according to certain exemplary embodiments of the present invention. As described in FIG. 4B, the parser module 208 may receive real-time operational data from the DEX module 204, which may include a number of signaling records. For each signaling record, the parser module 208 may identify a number of antennas serving (or communicably visible to) the mobile device 105. Further, the parser module 208 may generate a list 706 including the antennas serving the mobile device 105. In one embodiment, the list 706 may include a reference antenna. In another embodiment, the list 706 may include the reference antenna and one non-reference antenna. In some embodiments, the list 706 may include the reference antenna and a number of non-reference antennas. The non-references antennas may be sorted based on signal strength values and/or RTD values as described in FIG. 4B.

Further, for each signaling data the parser module 208 may retrieve information associated with each antenna in the list 706. The information associated with the antenna extracted from the signaling record may include at least a market identifier, a cell/tower identifier, a sector/antenna identifier, a round trip delay and/or signal strength.

In operation 720, the intersection module 702 may receive the list of antennas 706 and/or the information associated with the each antenna in the list 706. Using the received list of antennas 706 and information associated with each antenna, in operation 722, the intersection module 702 may access the cell sector database to retrieve appropriate data from the cell sector database for each antenna in the list 706. The data from the cell sector database 580 may be used to estimate the location of the mobile device 105. The process of retrieving appropriate data from the cell sector database based on the real-time operational data is described in the following paragraph, using an example.

In the example, a cell sector database 580 may include data representative of the sector geometries of antenna A, B and C in the wireless network 202. The antennas may belong to one tower 110 or different towers in the wireless network 202. Further, the cell sector database 580 may include data representative of range bands associated with each antenna, ring geometry for each range band, ring venue geometries, and ring road geometries. In the example embodiment, the DEX module 204 may stream real-time operational data from the wireless network 202 to the position determination engine 100. The real-time operational module may include a signaling record X associated with mobile device 105. The parser module 208 may process the signaling record X to generate a list of antennas communicably visible to (and/or serving) the mobile device 105 and information associated with each antenna in the list. In the example embodiment, the information from signaling record X may identify antenna A and antenna C as the serving antennas. Further, the list may identify antenna A as the reference antenna and antenna C as the non-reference antenna. The information associated with each of the antennas may include, RTD value associated with antenna A (e.g., 100) and RTD value associated with antenna C (e.g., 60). Once the RTD values are determined, the intersection module 702 may access the cell sector database 580 to retrieve sector geometry associated with antenna A and antenna C. Further, the intersection module 702 may retrieve the range band associated with antenna A which contains the RTD value 100 (corresponding distance value) (e.g., range band 10) and the range band associated with antenna C which contains the RTD value 60 (corresponding distance value) (e.g., range band 6). In addition, the rings and ring roads associated with range band 10 and range band 6 may be retrieved as well.

Once the appropriate data from the cell sector database is retrieved, in operation 724 the intersection module 702 may determine an overlapping region (e.g., common region, region of intersection, etc.) between the areas representative of the geometries retrieved from the cell sector database 580.

When the list includes one antenna, then the intersection module 702 may set the common region (or intersection region) as either the ring geometry and/or ring road geometry associated with the antenna. However, if the list includes more than one antenna, then the intersection module 702 may determine the common region by finding an intersection between one or more elements (e.g., rings, ring roads, sector geometry, etc.) of all the listed antennas.

The number of antennas in the list 706 may determine the number of constraints used to estimate the location of the mobile device 105. In some embodiments, the constraints may be relaxed to obtain a common region. The process of determining a common region when the list 706 includes a single antenna and/or multiple antennas may be described in greater detail in the following paragraphs.

### Estimating Region of Intersection Using Road Geometries

Case 1: When the list of antennas 706 includes a reference antenna and no non-reference antennas.
The process of the intersection module 702 may include:
1) Processing the signaling record obtained from the real-time operational data to extract an antenna identifier of the reference antenna (ref_id). The signaling record may be associated with the mobile device.
2) Extracting an RTD (RTD_ref) value of the reference antenna from the signaling record associated with the mobile device.
3) Identifying a range band (range_ref) of the reference antenna (ref_id) comprising the RTD_ref value.
4) Retrieving the ring geometry (or data) and/or ring road geometry (or data) associated with range_ref.

The intersection module 702 may retrieve the ring geometry and the ring road geometry using an appropriate function. In one embodiment, the function may return a value for the ring and/or ring road. In another embodiment, the function may return an empty value for the ring road. An empty ring road value may indicate that there are no roads intersecting the ring. In some embodiments, the function may return an empty value for the ring geometry. In one embodiment, an empty ring value may indicate that the range band corresponding to RTD value (RTD_ref) may be outside the sector geometry of the antenna and therefore does not intersect the sector geometry of the reference antenna. In another embodiment, an empty ring value may indicate that a range band comprising the RTD_ref value does not exist in the cell sector database 580. In an additional embodiment, the function may return multiple values for the ring road which may indicate that the ring geometry intersects and the road (or multiple roads) intersects at multiple locations within the ring (multiple disjoint ring roads for a given ring).

On the basis of the intersections, the intersection module 702 may determine the common region (region of intersection). In one embodiment, the common region may be identified as the ring road, if any. If there is no ring road, then the ring may be identified as the common region. If, both the ring and ring road does not exist then sector geometry of the reference antenna may be identified as the common region.

In another embodiment, the cell sector database may include the sector geometry of the antennas in the wireless network 202 and the road and venue map. The range bands, ring geometry and the ring road geometry may be created by the location module 210 as a part of the location estimation process. The location module 210 may create the range band based on RTD value of the antenna (in the list 706) received from the parser module 208. Using the sector geometry of the antenna from the cell sector database 580, the road and venue map from the cell sector database 580 and the created range band, the location module may determine a common region.

The process of estimating a common region and estimating a location therefrom for one antenna is illustrated in greater detail in FIG. 9A. FIG. 9A is a graphical representation of the location estimation process using information from one antenna, according to certain exemplary embodiments of the present invention. In particular, FIG. 9A illustrates the range band 654, the ring 656, the common region 910 and the estimated location 912. The process of estimating the location from the common region may be described in the following paragraphs, in association with FIG. 7B.

### Returning to FIG. 7B,

Case 2: When the list of antennas 706 include a reference antenna and a non-reference antenna.
The process of the intersection module 702 may include:
1) Processing the signaling record obtained from the real-time operational data to extract the antenna identifier of the reference antenna (ref_id) and non-reference antenna (non-ref_id). The signaling record may be associated with the mobile device.
2) Extracting the RTD value of the reference antenna (RTD_ref) and the RTD value of the non-reference antenna (RTD_non-ref) from the signaling record associated with the mobile device.
3) Identifying the range band (range_ref) comprising the RTD_ref value for the sector geometry corresponding to ref_id and the range band (range_non-ref) comprising the RTD_non-ref value for the sector geometry corresponding to non-ref_id.
4) Retrieving the ring geometry (data) and/or ring road geometry (data) associated with range_ref and range_non-ref.

In this case, the common region(s) may be defined as the geometry in which all the constraints are met. The constraints may include sector geometry of reference antenna (ref_id), sector geometry of non-reference antenna (non-ref_id), range_ref, range_non-ref, ring geometry of range_ref, ring geometry of range_non-ref, ring road geometry of range_ref and ring road geometry of range_non-ref. In an example embodiment, the common region(s) may be determined based on either one of the following equations that use AND operators:

Common region=(Ring Road reference AND Ring Road non-reference) (1)

Or

Common region=(Ring reference AND Ring non-reference)AND(Sector ref_id AND Sector non-ref_id)AND Road and venue map (2)

Equation 1 and Equation 2 may identify the common region(s) as a geometry obtained when all the constraints intersect. In other words, according to Equations 1 and 2, the mobile device 105 may be present in a region where the ring roads of the reference sector and the non-reference sector intersect or the mobile device may be present in the non-reference sector, the reference sector, the reference ring, the non-reference ring and the road and venue map. In another embodiment, the mobile device 105 may be present in a region where the ring road of the reference sector intersects the ring geometry of the non-reference antenna.

If the common region determined by Equations 1 or 2 returns an empty set i.e., when an intersection between all the constraints do not exist, then the conditions applied or the constraints may be relaxed. In an example embodiment, the condition or the constraints may be changed such that the mobile device may be located in either the sector geometry of the reference antenna OR the sector geometry of the non-reference antenna instead of using an AND operation. In an example embodiment, the common region(s) may be determined based on the following equation that uses an OR operator:

Common region=(Ring reference AND Ring non-reference)AND(Sector ref_id OR Sector non-re_id)AND Road and venue map (3)

If Equation 3 returns an empty value as well, the conditions or the constraints are further relaxed till at least one common region is determined. In no common region is identified, the sector geometry of the reference antenna may be defined as the common region.

In another embodiment, the cell sector database may include the sector geometry of the antennas in the wireless network 202 and the road and venue map. The range bands, ring geometry and the ring road geometry may be created by the location module 210 as a part of the location estimation process. The location module 210 may create the range band of the reference antenna and the non-reference antenna based on the RTD value of the reference antenna and the non-reference antenna respectively (in the list 706). Using the sector geometry of the reference and the non-reference antenna from the cell sector database 580, the road and venue map from the cell sector database 580 and the created range bands, the location module may determine a common region based on Equations 2 or 3. The process of estimating a common region and estimating a location therefrom is illustrated in greater detail in FIGS. 9B-9D.

FIG. 9B is a graphical representation of the location estimation process using information from a reference antenna and a non-reference antenna, according to certain exemplary embodiments of the present invention. In this example illustration all the constraints are met, i.e., the intersection of the reference and non-reference sectors 902 and 906, the reference and non-reference range bands 904 and 908, and the road and venue map covered by those sectors 906 and 902 is not empty. On the basis of the intersection, the common region may be determined as the geometry of region 910. Further, the location is estimated as location 912.

FIG. 9C is a graphical representation of the location estimation process using information from a reference antenna and a non-reference antenna having multiple intersection areas, according to certain exemplary embodiments of the present invention. In particular, FIG. 9C illustrates the non-reference sector 906, the reference sector 902, the non-reference range band 908, the reference band 904, the common region 910 and the estimated location 912. In FIG. 9C, the range bands 904 and 908 of the reference antenna and the non-reference antenna intersect at two different areas. In this case, one of the areas (of the range band intersection) may be eliminated based on the sector geometries of the antennas (e.g., 902 and 906). The elimination is made such the area intersecting with the sector geometries of the reference antenna and/or non-reference antenna is considered as common region.

FIG. 9D is a graphical representation of the location estimation process using information from a reference antenna and a non-reference antenna having concentric range bands, according to certain exemplary embodiments of the present invention. This case is an example of relaxing the “simultaneously on both range bands” constraint, because the area of intersection of range bands and the sector geometries do not overlap with a road segment, thereby resulting in an empty intersection. So the constraints may be relaxed. In order to relax the constraints the intersection module 702 may change the constraint condition to intersection “over at least one of the sectors”. In FIG. 9D, both the reference antenna and the non-reference antenna have ring roads. However, the ring road of the reference antenna is chosen in this case. The common region is reduced to the geometry represented by region 910.

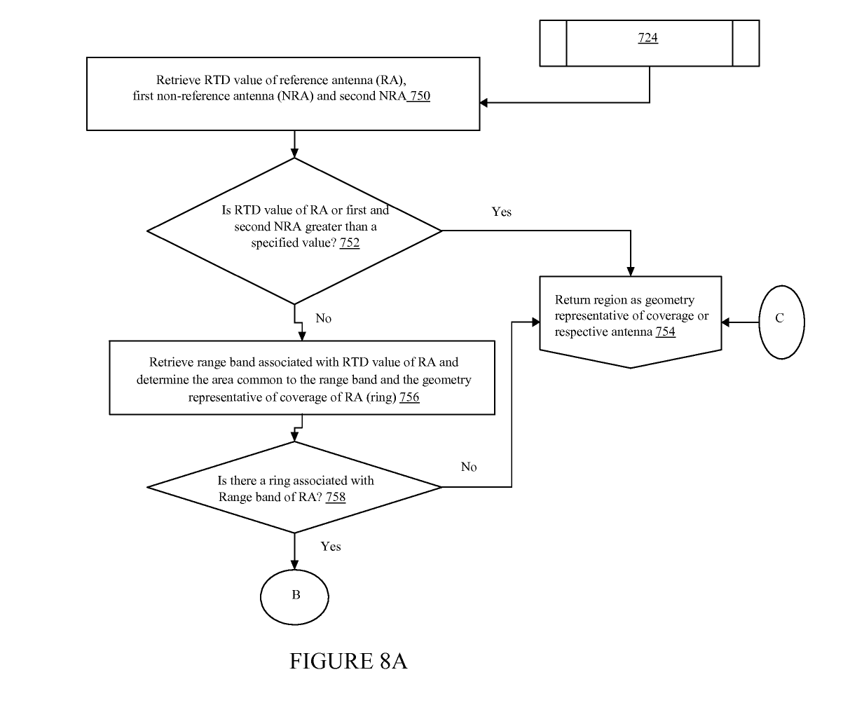

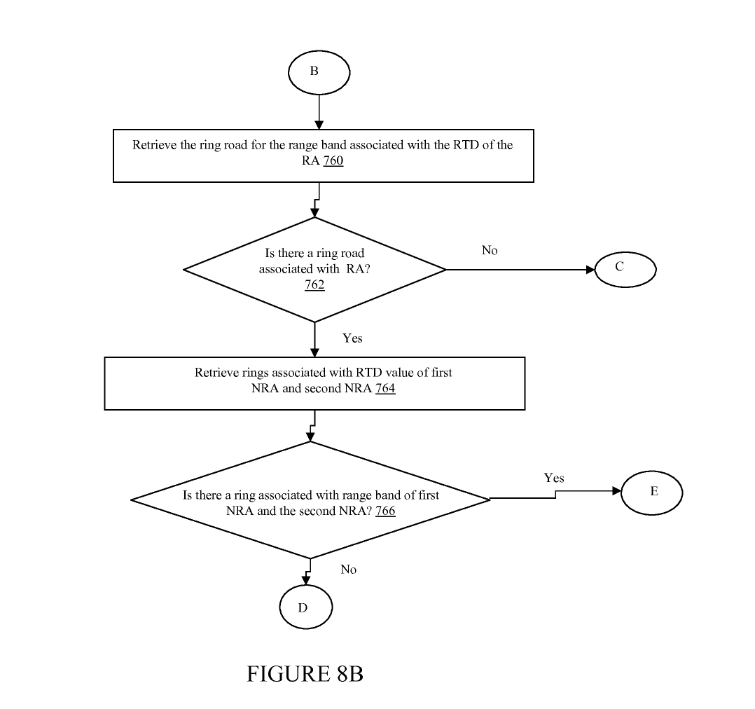

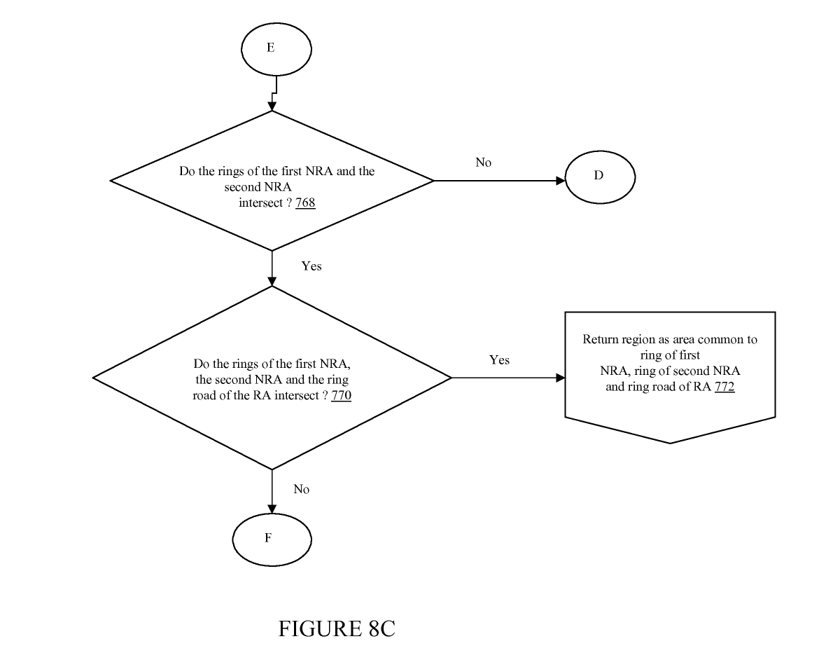

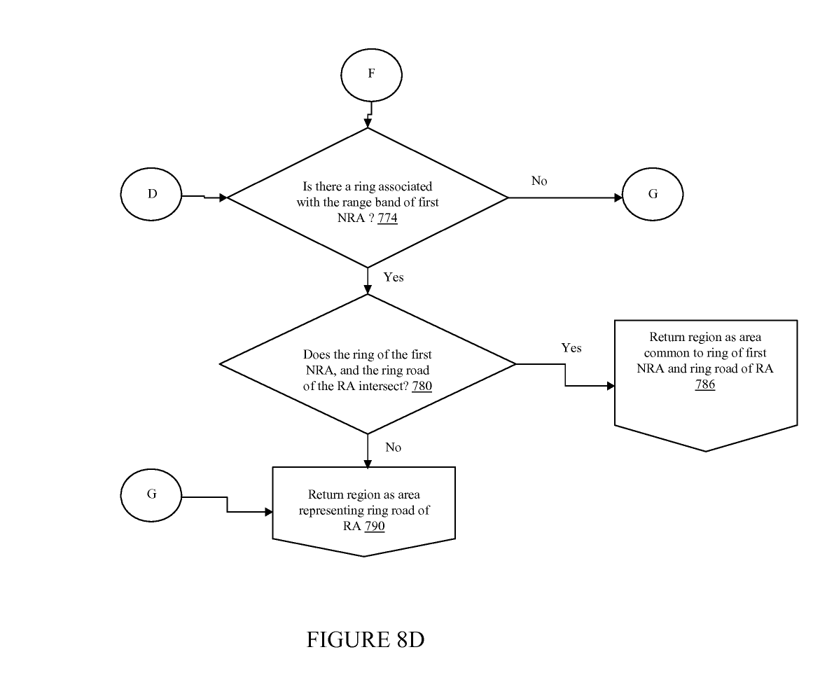

Turning now to FIGS. 8A-8D (collectively FIG. 8), FIG. 8 illustrates a process of determining common region for location estimation of a mobile device based on information from multiple antennas, according to certain exemplary embodiments of the present invention. In particular, FIG. 8 illustrates location estimation when the list of antennas 706 (representing antennas that service the mobile device at a given time) includes one reference antenna and two non-reference antennas.

In operation 750, the intersection module 702 may retrieve the RTD value of the reference antenna, the RTD value of the first non-reference antenna and the RTD value of the second non-reference antenna in the list 706. In one embodiment, the parser module 208 may provide the RTD value for each antenna in the list 706. In an alternate embodiment, the intersection module 702 may process the signaling record to extract the corresponding RTD values associated with each antenna in the list 706.

In some embodiments, the signaling data may not include an RTD data, instead there may be a Psuedo Noise Offset (PN Offset) value and a Phase value. In such embodiments where the RTD data is unavailable, the location module 210 may determine the number of antennas in the list 706. If there are two antennas on the list 706, then the location module 210 may generate an estimate location of the mobile device 105 based on geometric operations. But, if there are three antennas in the list 706, then the location module 210 may use numerical solutions to estimate a location of the mobile device 105. The numerical solutions can include a hyperbolic positioning solution. In one embodiment, when there are more than three antennas in the list 706, the list may be narrowed to three antennas based on various filtering logics. Using either of the solutions, may result in one or more estimated locations. Further, the one or more estimated locations are filtered by applying rules based on their Phase and Pn Offset. Finally, signal strength and distance value associated with the reference antenna may be used to enhance the filtered estimate location.

In another embodiment, even if the signaling record includes the RTD value, the location module 210 may use the PN offset and Phase value to estimate the location of the mobile device as described above. In other words, when the signaling record includes the RTD value, the location module 210 may estimate the location of the mobile device using RTD value. Further, the location module 210 may estimate the location of the mobile device using the PN Offset and Phase value. In some embodiments, both the location estimated based on the RTD value and the location estimated based on the PN Offset and Phase value may be the same. In another embodiment, the estimated locations may be different. If the estimated locations are different, the location module 210 may use a logic operation to choose one of the estimated locations between the one determined based on the RTD value and the one determined based on the PN Offset and Phase value.

Returning to FIG. 8A, in operation 752, the intersection module 702 may determine whether the RTD value of either one of the antennas in the list 706 is greater than a specified value. If the RTD value is greater than the specified value, the intersection module 702 may proceed to operation 754, where the intersection module 702 may define the sector geometry of the reference antenna as the common region. In operation 752, if it is determined that the RTD value is below the specified value, the intersection module 702 may proceed to operation 756. In operation 756, the intersection module 702 may access the cell sector database 580 to retrieve the range band geometry that includes the distance value corresponding to the RTD value of the reference antenna. In addition, the intersection module 702 may make appropriate function calls to retrieve the ring geometry associated with the range band geometry of the reference antenna.

In operation 758, if the function call for the ring geometry returns an empty value, the intersection module 702 may proceed to operation 754, in which the sector geometry of the reference antenna is defined as the common region. If the function call for the ring geometry returns a value, then the intersection module 702 proceeds to operation 760. In operation 760, the intersection module 702 may issue a function call to retrieve ring road geometry for the ring geometry of the reference antenna. In operation 762, if the function call for the ring road geometry returns an empty value, the intersection module 702 may define the sector geometry of the reference antenna as the common region (in operation 754). However, if the function call for the ring road returns a value, the intersection module 702 may proceed to operation 764.

In operation 764, the intersection module 702 may issue a function call to retrieve both the ring geometries associated with the first non-reference antenna and the second non-reference antenna. Based on the value of the function call, the intersection module 702 may proceed to either operation 774 or operation 768. If the function call for ring geometries of the first non-reference antenna (associated with RTD value of first non-reference antenna) and the second non-reference antenna ((associated with RTD value of first non-reference antenna) returns a value, then the intersection module proceeds to operation 768. In operation 768, the intersection module 702 checks if the ring geometries of the first non-reference antenna and the second non-reference antenna intersect. If they intersect, the intersection module 702 may proceed to operation 770, where an additional constraint is added. The additional constraint may be the ring road of the reference antenna. In operation 770, the intersection module 702 checks if the ring geometry of the first non-reference antenna, ring geometry of the second non-reference antenna and the ring road geometry of the reference antenna intersect with each other. If the ring geometries of the first non-reference antenna and the second non-reference antenna and the ring road geometry of the reference antenna intersect, intersection module 702 may proceed to operation 772. In operation 772, the intersection module 702 may define the geometry (or region) representative of the area of intersection of the he first non-reference antenna and the second non-reference antenna intersect and the ring road geometry of the reference antenna, as the common region.

If the ring geometries of the first non-reference antenna and the second non-reference antenna and the ring road geometry of the reference antenna do not intersect, the intersection module 702 may proceed to operation 774. Returning to operation 766, if the function call for ring geometries of the first non-reference antenna and the second non-reference antenna returns an empty value, the intersection module 702 may proceed to operation 774. In operation 774, the intersection module 702 may check if the cell sector database contains the ring geometry of the first non-reference antenna. If the cell sector database 580 contains the ring geometry of the first non-reference antenna, then the location module may retrieve the ring geometry of the first non-reference antenna and proceed to operation 780. In operation 780, the intersection module 702 checks if the ring geometry of the first non-reference antenna intersects the ring road geometry of the reference antenna. If the ring geometry of the first non-reference antenna intersects the ring road geometry of the reference antenna, in operation 786 the intersection module 702 may define the geometry representative of the area of intersection between the ring geometry of the first non-reference antenna and the ring road geometry of the reference antenna as the common region.

If either the cell sector database does not contain the ring geometry of the first non-reference antenna or the ring geometry of the first non-reference antenna does not intersects the ring road geometry of the reference antenna, the intersection module 702 may define the ring road geometry of the reference antenna as the common region.

Briefly, the intersection module 702 may check whether the reference antenna has a ring road associated with the RTD value of the reference antenna. If there is a ring road, the intersection module 702 may check if the non-reference antennas have ring geometries associated with their respective RTD values and then tries to find an intersection between the ring roads of the reference antenna and the rings of the non-reference antennas. If such an intersection does not exist, then the intersection module 702 may relax the constraint, by trying to find an intersection between the ring road of the reference antenna and the ring geometry of the first non-reference antenna. If such an intersection does not exist for the relaxed constraint, then the ring road of the reference antenna may be set as the common region. However, if any of the said intersections do exist, then the intersection module 702 defines the geometry representative of the area of intersection as the common region.

Further, if the ring road geometry for the reference antenna does not exist, the sector geometry of the reference antenna is set as the common region. The intersection module 702 may return the common region to the location module 704.

Returning to FIG. 7B, in operation 726 the location module 704 may receive the common region 910 (or respective data) from the intersection module 702 and calculate a weighted average center 912 of the one or more common regions. Further, in operation 728, the calculated center may be set as the estimated location and stored in a location database. The end users 212 may access the location using an API. The process ends at operation 730. In one embodiment, the operations of FIG. 7B may be repeated for each signaling record of the real-time operational data, to determine locations of each mobile station associated with each signaling record.

With reference to FIG. 7B, the following paragraphs may describe in detail how a common region is estimated using a venue geometry.

### Estimating Region of Intersection Using Venue Geometries

As described above, in an example embodiment, the modeling module 206 can receive a first operational data 350 from the wireless network 202. Using the first operational data 350, the range band module 508 of the modeling module 206 can generate a number of range bands for each antenna based on RTD values from the first operation data 350. Further, using the first operational data 350 and tower/antenna data 352, the lobe generation module 506 of the modeling module 206 can generate a geometry representative of coverage area of the antenna (sector geometry of the antenna). Once the sector geometry of the antenna and the range band geometries are generated, the ring module 510 can generate the ring geometries, ring road geometries, and the ring venue geometries.

As described above in association with FIG. 5B, the ring venue module 1002 can mathematically or logically intersect the ring geometry with the road and venue map. The road and venue map may include geometries representative of different venues in a region associated with the wireless network 202. Further, the venue map can be a weighted map with each of the venues in the venue map may be assigned a value (e.g., weights) based on various parameters. If the ring geometry intersects with the venue geometry, the geometry representing the region of intersection may be stored in the cell sector coverage map database 580 as a ring venue geometry.

Further, the location module 210 may receive a second operational data. Once the second operational data 360 is received, the location module 210 may process the second operational data 360 to determine the reference antennas and the non-reference antennas listed in the second operational data 360. Further, the location module 210 may determine if the reference antennas and/or the non-reference antennas are listed among the antennas that service a venue. In an example embodiment, if the reference antennas and/or the non-reference antennas are listed among the antennas that service a venue, the venue 1104 may be represented as the common region 910 based on which the location of the mobile device is estimated. In another example embodiment, the ring venue geometry may be assigned as the common region. Once the common region 910 is determined, the location module may calculate a weighted average center 912 of the common region 910. The weighted average center 912 may be represented as the estimated location of the mobile device.

In other words, the venue may be used as a common region 910 to estimate a location of the mobile device, if the antennas listed in the second operational data are also listed as antennas that service a venue. Further, the venues may or may not be intersected with the range bands, rings, and/or road geometries to determine the common region 910.

Returning to FIG. 7B, in an example embodiment, if a reference antenna is in a close vicinity of a venue in the venue map, then instead of estimating the location of the mobile device based on an common region comprising a ring road geometry, a common region comprising a ring venue geometry may be used for location estimation.

Case 1: When the list of antennas 706 servicing the mobile device includes a reference antenna and no non-reference antennas.
The process of the intersection module 702 may include:
5) Processing the signaling record obtained from the real-time operational data to extract an antenna identifier of the reference antenna (ref_id). The signaling record may be associated with the mobile device.
6) Extracting an RTD (RTD_ref) value of the reference antenna from the signaling record associated with the mobile device.
7) Identifying a range band (range_ref) of the reference antenna (ref_id) comprising the RTD_ref value.
8) Retrieving the ring geometry (or data) and/or ring venue geometry (or data) associated with range_ref.

In an example embodiment, the intersection module 702 may retrieve the ring geometry and the ring venue geometry using an appropriate function that may return a value for the ring and/or ring venue if any. In some embodiments, the function may return an empty value for the ring venue geometry. An empty ring venue value may indicate that there are no venues intersecting the ring. In another embodiment, the function may return an empty value for the ring geometry. In yet another embodiment, the function may return multiple values for the ring venue geometry which may indicate that the ring geometry and the venue geometry (or multiple venues) intersects at multiple locations within the ring (multiple disjoint ring venues for a given ring) or multiple venues intersect the ring geometry.

Responsive to obtaining the ring geometry and/or ring venue geometry, the intersection module 702 may determine the common region (region of intersection). In one embodiment, the common region may be represented by the ring venue geometry, if any. If the ring venue geometry is empty as discussed above, then the ring geometry may be identified as the common region. If, both the ring geometry and ring venue geometry do not exist, then sector geometry of the reference antenna may be identified as the common region. However, if multiple ring venues geometries are present within a ring associated with the reference antenna, then the ring venue having the highest rank may be assigned as the common region. In another embodiment, when multiple ring venues are present, the ring venue that has been associated with the most number of previous location estimations may be assigned as the common region. For example, if a ring venue has been estimated as the location of a mobile device in a number of previous location estimation operations, then said ring venue may be assigned as the common region.

Case 2: When the list of antennas 706 include a reference antenna and a non-reference antenna.
The process of the intersection module 702 may include:
5) Processing the signaling record obtained from the real-time operational data to extract the antenna identifier of the reference antenna (ref_id) and non-reference antenna (non-ref_id). The signaling record may be associated with the mobile device.
6) Extracting the RTD value of the reference antenna (RTD_ref) and the RTD value of the non-reference antenna (RTD_non-ref) from the signaling record associated with the mobile device.
7) Identifying the range band (range_ref) comprising the RTD_ref value for the sector geometry corresponding to ref_id and the range band (range_non-ref) comprising the RTD_non-ref value for the sector geometry corresponding to non-ref_id.
8) Retrieving the ring geometry (data) and/or ring venue geometry (data) associated with range_ref and range_non-ref.

In an example embodiment of Case 2, the common region(s) may be determine based on the following equations:

Common region=(Ring venue_reference AND Ring venue_non-reference) (4)

Or

Common region=(Ring reference AND Ring non-reference)AND(Sector ref_id AND Sector non-ref_id)AND Venue geometry (5)

According to Equations 4 and 5, the mobile device 105 may be present in a region where the ring venues of the reference sector intersects the rings of the non-reference sector. Equation 4 and Equation 5 may identify the common region(s) as a geometry obtained when all the constraints intersect. The constraints may include, inter alia, sector geometry of reference antenna (ref_id), sector geometry of non-reference antenna (non-ref_id), range_ref, range_non-ref, ring geometry of range_ref, ring geometry of range_non-ref, ring venue geometry of range_ref and ring venue geometry of range_non-ref. In other words according to Equation 4 and 5, the mobile device may be present in a region where the non-reference sector, the reference sector, the reference ring, the non-reference ring and the venue map intersect.

If the common region determined by Equations 4 or 5 returns an empty set i.e., an intersection between all the constraints do not exist, then the conditions applied on the constraints may be relaxed. In an example embodiment, the condition on the constraints may be changed such that the mobile device may be located in either the sector geometry of the reference antenna OR the sector geometry of the non-reference antenna instead of using an AND operation. In an example embodiment, the common region(s) may be determined based on the following equation that uses an OR operator:

Common region=(Ring reference AND Ring non-reference)AND(Sector ref_id OR Sector non-ref_id)AND Venue geometry (6)

If Equation 6 returns an empty value as well, the conditions on the constraints are further relaxed till at least one common region is determined. If no common region is identified, the sector geometry of the reference antenna may be defined as the common region. The process of estimating a common region and estimating a location therefrom for cases 2 and 3 are illustrated in FIGS. 11-13.

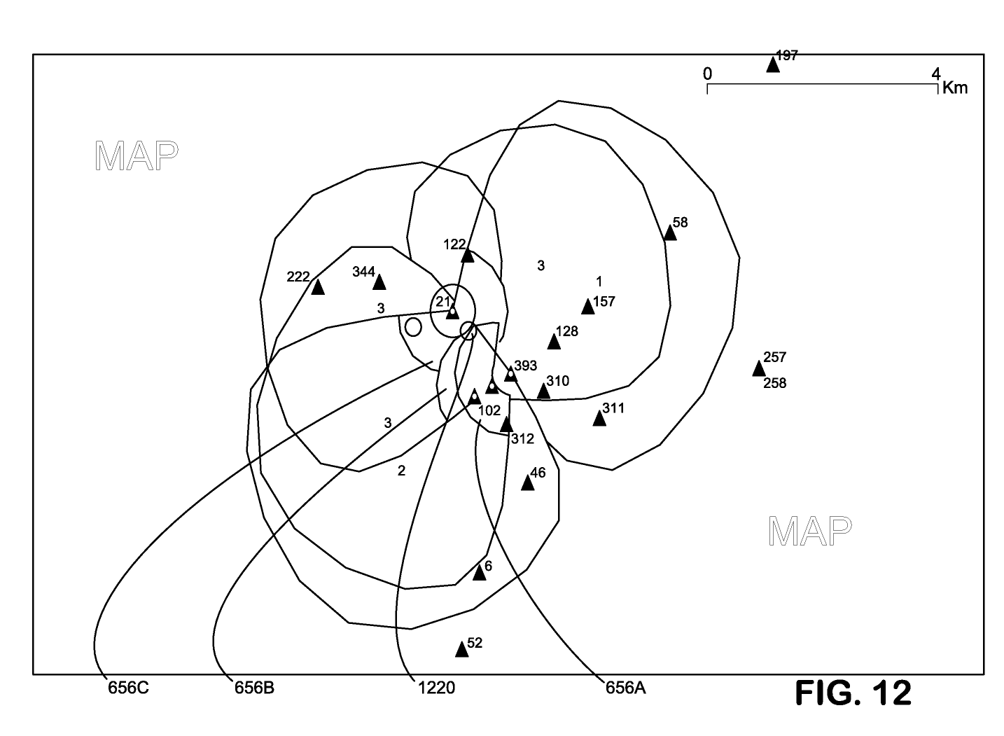

Turning now to FIG. 11, this figure illustrates estimating a location of a mobile device based on venue geometries, according to certain exemplary embodiments of the present invention. In particular FIG. 11 illustrates antennas 1612, 1573, 339, 150 and 154 and the sector geometries of the coverage areas associated with the respective antennas. For example, sector geometries 1102 and 1104 are associated with the antenna 1612, sector geometry 1106 is associated with antenna 1573, and sector geometry 1108 is associated with antenna 154. Using the modeling module 206, antennas servicing a venue 1120 are determined based on a threshold parameter such as RTD value. In the exemplary embodiment of FIG. 12, antennas 1612, 1573 and 154 may be listed as antennas that service the venue 1120. Further, sector geometries 1104 and 1108 cover the whole venue 1120, whereas the other sector geometries cover portions of the venue 1120.

In one embodiment, the location module 210 may receive a second operational data that may be processed to determine the antennas listed in the second operational data. If the antennas 1612, 1572 and/or 154 are listed in the second operational data, then venue 1120 may be determined as the common region 910 based on which the location of the mobile device may be estimated. In another embodiment, the ring venue may be assigned as the common region. However, in the example embodiment of FIG. 12, the both the ring venue geometry and the venue geometry 1120 serviced by the reference antennas listed in the second operational data are the same. In an example embodiment, if there are more than one venues associated with the antenna, then a weighted average center of the venues may be determined or venues having a higher rank may be assigned as the common region.

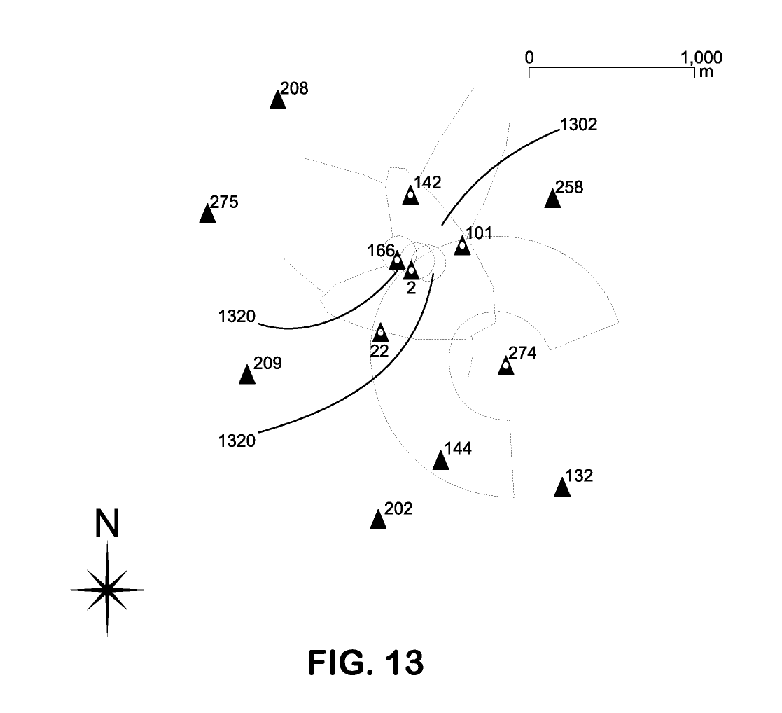

Further, in some embodiments the estimation location may result in finding more than one value that represents a location the mobile device. When, the location estimation results in multiple locations, each of the locations may be assigned an error radius. Further, based on the assigned error radius the estimation may be refined to obtain an accurate location estimation for the mobile device 105. Additional example of the process of estimating a common region and estimating a location therefrom is illustrated in greater detail in FIGS. 12 and 13.

Turning to FIG. 12, FIG. 12 illustrates estimating a location of a mobile device based on venue geometries when more a venue geometry intersects more than one ring geometries, according to certain exemplary embodiments of the present invention. In particular, FIG. 12 illustrates ring geometries 656A, 656B, and 656C associated with the antennas identified in the list 706 that service a mobile device 105 of interest. Further, as illustrated in the figure, each antenna associated with the ring geometries 656A, 656B, and 656C also service the venue 1220 either partially or in whole. In one embodiment, the location module 210 may intersect the ring geometries 656A, 656B, and 656C with the geometry 1220 to determine a common region. Eventually, the location may be estimated as a weighted center of the venue 1220. However, in some embodiments, each antenna that services a mobile device 105 of interest, may also service one or more venues as illustrated in FIG. 13.

Turning to FIG. 13, FIG. 13 illustrates estimating a location of a mobile device based on venue geometries when more than one venue geometry is present, according to certain exemplary embodiments of the present invention. In particular, FIG. 13 illustrates the sector geometry 1302 of an antenna 166. In an example embodiment, the list of antennas 706 retrieved by the parser module may identify antenna 166 as a reference antenna. Further, the location module 210 determines that the reference antenna 166 also services one or more venues 1320. In this example embodiment, as illustrates in FIG. 13, the location module 210 may determine if the one or more venues 1320 intersect each other. Further, the area representing the intersected region may be assigned as the common region which is eventually used in estimating the location of the mobile device 105.

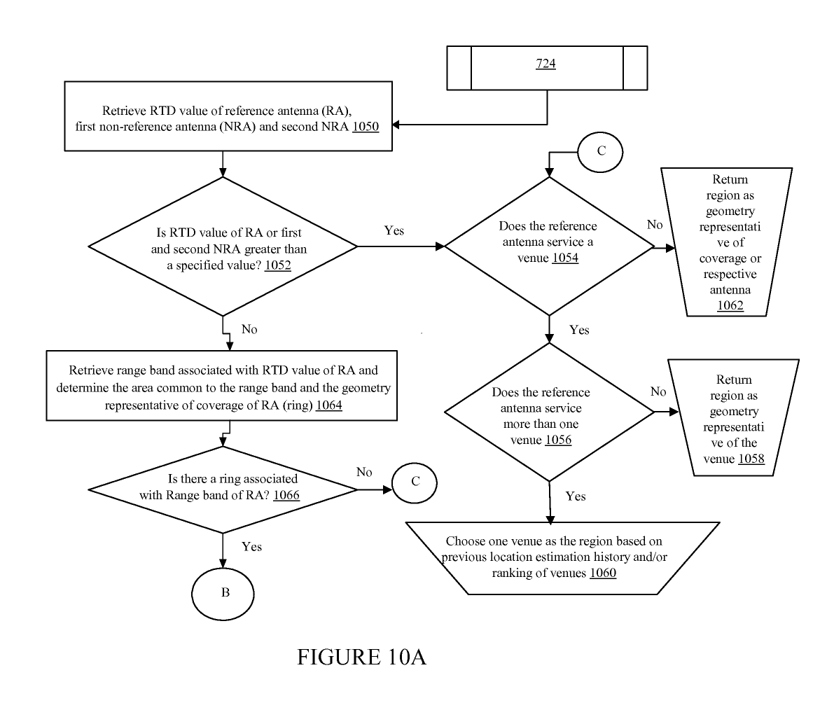

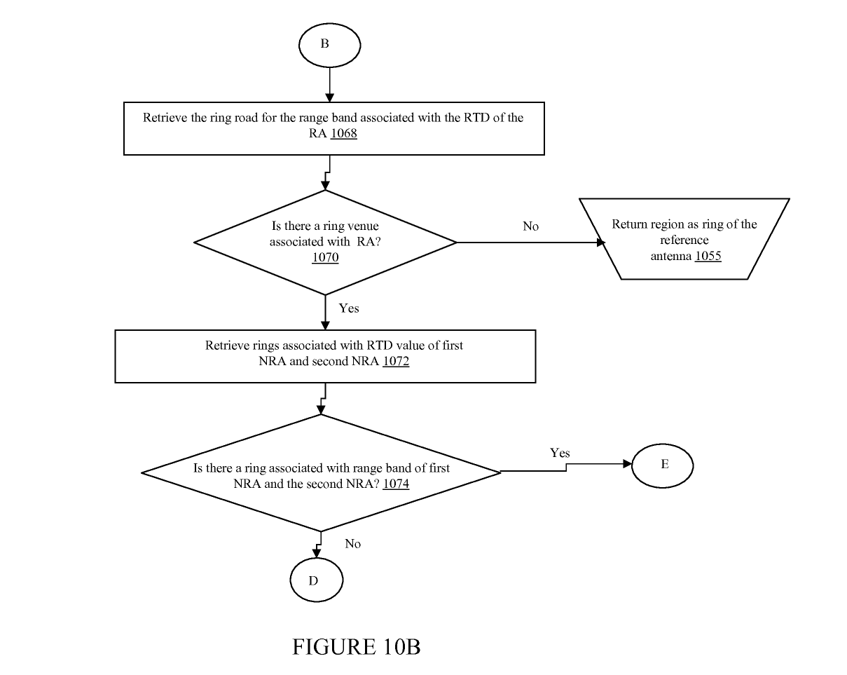

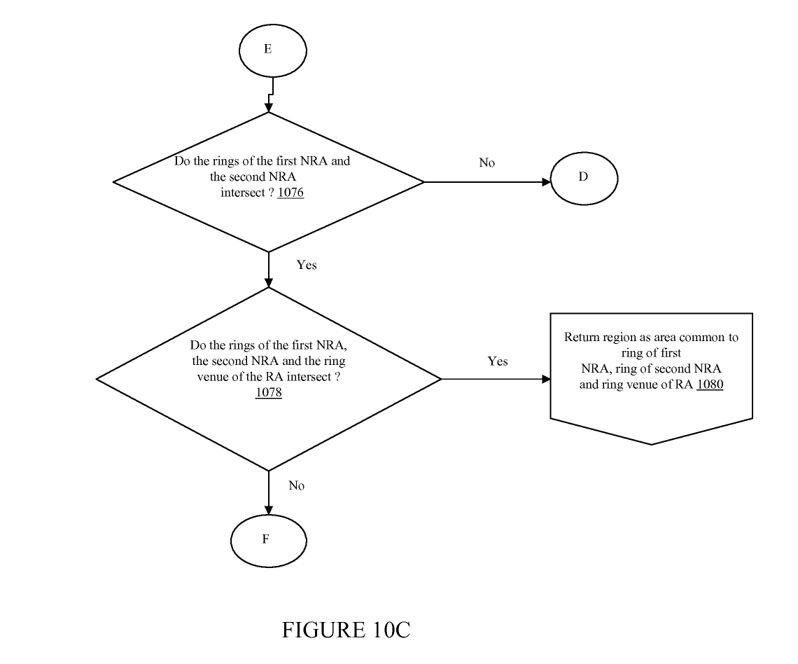

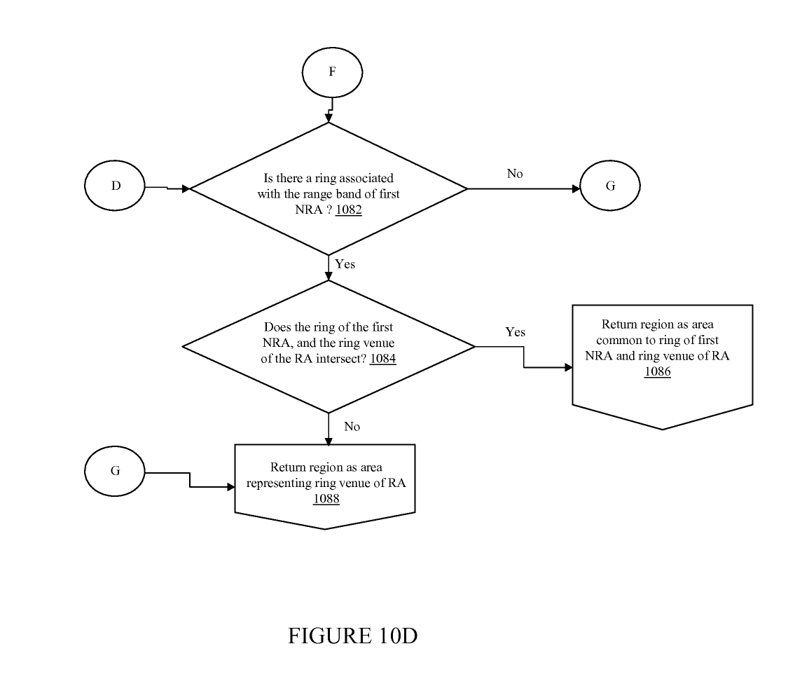

Turning now to FIGS. 10A-10D (collectively FIG. 10), FIG. 10 illustrates a process of determining common region for location estimation of a mobile device based on information from multiple antennas and venue geometries, according to certain exemplary embodiments of the present invention. In particular, FIG. 10 illustrates location estimation when the list of antennas 706 (representing antennas that service the mobile device at a given time) includes one reference antenna and two non-reference antennas.

In operation 1050, the intersection module 702 may retrieve the RTD value of the reference antenna, the RTD value of the first non-reference antenna and the RTD value of the second non-reference antenna in the list 706.

In operation 1052, the intersection module 702 may determine whether the RTD value of either one of the antennas in the list 706 is greater than a specified value. If the RTD value is greater than the specified value, the intersection module 702 may proceed to operation 1054, where the intersection module 702 may determine if the reference antenna from the list 706 services a venue. If the reference antenna does service a venue, in operation 1056, the location module 210 may determine how many venues the reference antenna services. If there are more than one venues that the reference antenna services, then in operation 1058, the location module 210 assigns one venue as the common region based on previous location estimation history and/or ranks associated with each of the venues. However, in operation 1056, if the location module 210 determines that the reference antenna services one venue, then in operation 1060 the one venue may be assigned as the common region.

Further, referring back to operation 1054, if the location module 210 determines that the reference antenna does not service a venue, then in operation 1062, the location module 210 may define the sector geometry of the reference antenna as the common region.

Referring back to operation 1052, if the RTD value is below the specified value, the intersection module 702 may proceed to operation 1064. In operation 1064, the intersection module 702 may access the cell sector database 580 to retrieve the range band geometry that includes the distance value corresponding to the RTD value of the reference antenna. In addition, the intersection module 702 may make appropriate function calls to retrieve the ring geometry associated with the range band geometry of the reference antenna.

In operation 1066, if the function call for the ring geometry returns an empty value, the intersection module 702 may proceed to operation 1054, which further proceeds to either operation 1058, operation 1060, or operation 1062 where the common region is defined. However, if the function call for the ring geometry returns a value, then the intersection module 702 proceeds to operation 1068, where the intersection module 702 may issue a function call to retrieve ring venue geometry for the ring geometry of the reference antenna. In operation 1070, if the function call for the ring venue geometry returns an empty value, the intersection module 702 may proceed to operation 1055 to define the ring of the reference antenna as the common region. However, if the function call for the ring venue returns a value, the intersection module 702 may proceed to operation 1072.

In operation 1072, the intersection module 702 may issue a function call to retrieve both the ring geometries associated with the first non-reference antenna and the second non-reference antenna. Based on the value of the function call, the intersection module 702 may proceed to either operation 1082 or operation 1076. In operation 1074, if the function call for ring geometries of the first non-reference antenna (associated with RTD value of first non-reference antenna) and the second non-reference antenna ((associated with RTD value of first non-reference antenna) returns a value, then the intersection module proceeds to operation 1076. In operation 1076, the intersection module 702 checks if the ring geometries of the first non-reference antenna and the second non-reference antenna intersect. If they intersect, the intersection module 702 may proceed to operation 1078, where an additional constraint is added. The additional constraint may be the ring venue of the reference antenna. Accordingly, in operation 1078, the intersection module 702 checks if the ring geometry of the first non-reference antenna, ring geometry of the second non-reference antenna and the ring venue geometry of the reference antenna intersect with each other. If the ring geometries of the first non-reference antenna and the second non-reference antenna and the ring road geometry of the reference antenna intersect, intersection module 702 may proceed to operation 1080. In operation 1080, the intersection module 702 may define the geometry (or region) representative of the area of intersection of the ring of the first non-reference antenna, the second non-reference antenna intersect, and the ring venue geometry of the reference antenna, as the common region.

If the ring geometries of the first non-reference antenna and the second non-reference antenna and the ring road geometry of the reference antenna do not intersect, the intersection module 702 may proceed to operation 1082. Returning to operation 1072, if the function call for ring geometries of the first non-reference antenna and the second non-reference antenna returns an empty value, the intersection module 702 may proceed to operation 1082. In operation 1082, the intersection module 702 may check if the cell sector database contains the ring geometry of the first non-reference antenna. If the cell sector database 580 contains the ring geometry of the first non-reference antenna, then the location module may retrieve the ring geometry of the first non-reference antenna and proceed to operation 1084. In operation 1084, the intersection module 702 checks if the ring geometry of the first non-reference antenna intersects the ring venue geometry of the reference antenna. If the ring geometry of the first non-reference antenna intersects the ring road geometry of the reference antenna, in operation 1086, the intersection module 702 may define the geometry representative of the area of intersection between the ring geometry of the first non-reference antenna and the ring venue geometry of the reference antenna as the common region.

If either the cell sector database does not contain the ring geometry of the first non-reference antenna or the ring geometry of the first non-reference antenna does not intersect the ring road geometry of the reference antenna, in operation 1088, the intersection module 702 may define the ring venue geometry of the reference antenna as the common region.

Briefly, the intersection module 702 may check whether the reference antenna has a ring road associated with the RTD value of the reference antenna. If there is a ring road, the intersection module 702 may check if the non-reference antennas have ring geometries associated with their respective RTD values and then tries to find an intersection between the ring roads of the reference antenna and the rings of the non-reference antennas. If such an intersection does not exist, then the intersection module 702 may relax the constraint, by trying to find an intersection between the ring road of the reference antenna and the ring geometry of the first non-reference antenna. If such an intersection does not exist for the relaxed constraint, then the ring road of the reference antenna may be set as the common region. However, if any of the said intersections do exist, then the intersection module 702 defines the geometry representative of the area of intersection as the common region.

In one example embodiment, after determining a ring venue associated with the reference antenna in operation 1068, the location module 210 may be configured to determine if there are any ring road geometries associated with the ring of the reference antenna. If so, then the location module 210 may be configured to determine if the intersection of a ring of the first non-reference antenna with the ring of the second non-reference antenna further intersects the ring road geometry and the ring venue geometry. If they intersect, then the location module 210 may have to choose between the ring venue geometry and the ring road geometry to assign a common region. In some embodiments, both the ring venue geometry and the ring road geometry may be assigned as the common region and a centroid between the ring road geometry and the ring venue geometry may be assigned as the estimated location of the mobile device. However, if the location module 210 has to choose between the ring venue and the ring road geometries to assign the common region, then the location module 210 may be configured to continue collecting second operational data for a specified period of time. Further, the location for each signaling data of the collected second operation data may be estimated (previous second operational data of the mobile device 105 over past x minutes, or over next x minutes). If the location tends to move, then the ring road may be assigned as the common region, but if the location is stationary over the specified period of time then the ring venue may be assigned as the common region. Either way, after the common region is assigned, then the weighted center of the common region may be determined as the estimate location of the mobile device 105.

In one embodiment, if the location module 210 determines that the list of antennas 706 that service a mobile device 105 are also listed in a list of antennas that service a venue, then the location module 210 may bypass the operations of intersecting the venue geometry with the ring geometries and sector geometries. Instead, the location module 210 may directly assign the venue as the common region 910. Further, the estimated location 912 may be calculated as a center and/or weighted center of the venue geometry.

In an example embodiment, as described above the position determination engine 100 may receive a list of venues from an external source. Further, from among the list of venues, some venues may be categorized as special venues based on a set of criteria. One example of the criteria may be capacity of the venue, for example, a venue representative of a stadium that can hold more than 40,000 people may be categorized as a special venue. If the list of antennas that service a mobile device 105, is also identified as antennas that service a special venue, then the location module 210 may directly assign the special venue as the location of the mobile device 105. When a venue is directly assigned as the estimated location, the operations of intersecting the venue geometry with the rings and sector geometries as described in FIGS. 9 and 10 may be skipped or omitted. In some embodiments, the center of the special venue may be assigned as the location of the mobile device 105.

In one example, when an assigned common region 910 used for location estimation includes more than one special venues located close to each other, the location module may determine a point that approximately equidistant from the more the one special venues. Further, the determined point may be qualified as the estimated location. In addition, for statistical purposes, the estimated location may be assigned to each of the closely spaced venues. For example, if a reference antenna that services a mobile device also services three venues that are close to each other, the location module 210 may qualify all three venues as the estimate location for statistical purposes (i.e., for example to get a count of where the user of the mobile device was present), and may assign a point that is equidistant from the three venues as the estimated location for purposes of accurate location determination or the center of each of the three venues may be assigned as the estimated location. Further, the location may be refined based on additional data from an external source, such as events occurring at each of the venues. If an event is occurring at only one of the three venues, then the venue where the event is occurring may eventually be assigned as the estimated final location.

Further, in some embodiments, once the venue is directly assigned as the common region 910 (e.g., bypassing the intersection operations), the location module 210 may further confirm the accuracy of such an assignment. In an example embodiment, the location module 210 may confirm the accuracy of such an assignment based on an observed pattern of antenna behavior of the antenna of concern and/or a group of antennas associated with the venue of concern. For example, the location module 210 may confirm an accuracy of the assignment by analyzing the RTD spread pattern associated with the reference antenna and/or non-reference antennas that service a mobile device whose location is being estimated. In another example embodiment, the location module 210 may confirm the accuracy of such an assignment based on continual sightings and/or a combination of other factors.

In another embodiment, the location module 210 may estimate a location of a mobile device using rings, sector geometries, road geometries, and/or range bands as described in FIGS. 9A-9D. Further, once the location is estimated, the location module 210 may overlay the estimated location on a grid map representative of an area of coverage of the wireless network system. The grid map may be received from an external source, and the grid map may generally include a map that has been sectored into grids. Further, the grid map may include various points of interest and venue locations which may be located within a grid sector of the map. Upon overlaying the estimated location on the grid map, if the estimated location falls within a grid sector that includes a point of interest and/or venue, then the location module 210 may qualify the corresponding point of interest and/or venue as the estimated location.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
for each antenna of a plurality of antennas in an area associated with a wireless network, creating, by a server, a sector geometry representative of a coverage area of each antenna based on a tower data of the wireless network and first operational data from the wireless network;
for each antenna, generating, by the server, one or more range bands, each bound by a first distance and a second distance based on the first operational data and the tower data;
receiving, by the server, a model of a plurality of sites for the area associated with the wireless network; and
estimating, by the server, a location of a mobile device in the wireless network based on the sector geometry of one or more antennas from the plurality of antennas, the one or more range bands of each of the selected one or more antennas, the model of the plurality of sites, and second operational data.

2. The method of claim 1, wherein the estimated location of the mobile device is assigned a value representative of distance offset of estimated location from an actual location with an X percent confidence.

3. The method of claim 1, further comprising selecting the one or more antennas from the plurality of antennas to estimate the location of the mobile device, wherein the one or more antennas are selected based on the second operational data.

4. The method of claim 3, wherein selecting one or more antennas from the plurality of antennas further comprises:
extracting, by the server, a signaling record from the second operational data, wherein the second operation data is obtained from the wireless network; and
based on the signaling record, identifying, by the server, the one or more antennas communicatively associated with the mobile device.

5. The method of claim 1, wherein the one or more antennas comprises at least one of a reference antenna and one or more non-reference antennas.

6. The method of claim 1, wherein location of the mobile device is estimated based on a reference antenna.

7. The method of claim 5, wherein the one or more non-reference antennas are sorted based on a signal strength value associated with each of the non-reference antennas.

8. The method of claim 1, further comprising: based on a round trip delay value associated with a reference antenna, selecting a range band from the one or more range bands of the reference antenna to estimate the location of the mobile device associated with the antenna, the round trip delay value associated with the antenna is obtained from the signaling record associated with the second operational data.

9. The method of claim 7, wherein when the signaling record associated with the second operational data is devoid of the round trip delay value, the server is configured to estimate the location of the mobile device based on a pseudo noise offset value and a phase value present in the signaling record.

10. A system, comprising:
a position determination engine, the position determination engine comprising:
a modeling module configured to:
for each antenna of a plurality of antennas in an area associated with a wireless network, create a sector geometry representative of a coverage area of each antenna based on a tower data of the wireless network and historical signaling data from the wireless network;
receive a geospatial model of a plurality of sites for the area associated with the wireless network; and
for each antenna, generate one or more range bands, each bound by a first distance and a second distance based on the tower data;
a location module configured to estimate a location of a mobile device in the wireless network based on:
the sector geometry of one or more antennas selected from the plurality of antennas,
the geospatial model of the plurality of sites,
the one or more range bands of the at least one antenna, and
real-time signaling data obtained from the wireless network.

11. The system of claim 9, wherein the location module is configured to assign, to the estimated location of the mobile device, a value representative of distance offset of estimated location from an actual location with an X percent confidence.

12. The system of claim 9, further comprising:
a parsing module configured to:
extract a signaling record from the real-time signaling data, wherein the real-time signaling data is obtained from the wireless network; and
based on the signaling record, identify the one or more antennas communicatively associated with the mobile device, wherein the one or more antennas comprises at least one of a reference antenna and one or more non-reference antennas

13. The system of claim 11, wherein the one or more non-reference antennas are sorted based on a signal strength value associated with each of the non-reference antennas.

14. The system of claim 9, wherein the location module is configured to select, based on the real time signaling data, the one or more antennas from the plurality of antennas to estimate the location of the mobile device.

15. The system of claim 11, wherein when the signaling record associated with the second operational data is devoid of a round trip delay value, the location module is configured to estimate the location of the mobile device based on a pseudo noise offset value and a phase value present in the signaling record.

16. A server, comprising:
a memory; and
a processor configured to:
for each antenna of a plurality of antennas in an area associated with a wireless network, create a sector geometry representative of a coverage area of each antenna based on a tower data of the wireless network and first operational data from the wireless network;
receive a geospatial model of a plurality of sites for the area associated with the wireless network; and
estimate a location of a mobile device in the wireless network based on:
the sector geometry of one or more antennas selected from the plurality of antennas,
the geospatial model of the plurality of sites, and
second operational data.

17. The position determination engine of claim 15, wherein the processor is configured to generate, for each antenna of the one or more antennas, one or more range bands, each bound by a first distance and a second distance from the antenna based on the first operational data.

18. The position determination engine of claim 15, wherein the processor is configured to:
extract signaling record from the second operational data, wherein the second operation data is obtained from the wireless network;
based on the signaling record, identify the one or more antennas communicatively associated with the mobile device, wherein the one or more antennas comprises at least one of a reference antenna and one or more non-reference antennas; and
determine, based on the signaling record, at least one of a round trip delay (RTD) value associated with the antenna and an RTD value associated with the non-reference antenna.

19. The positioning determination engine of claim 17 wherein the one or more non-reference antennas are sorted based on a signal strength value associated with each of the non-reference antennas.

20. The position determination engine of claim 17,
wherein based on round trip delay value associated with the reference antenna, the processor is configured to select a range band from the one or more range bands of the reference antenna to estimate the location of the mobile device associated with the antenna; and
wherein when the signaling record associated with the second operational data is devoid of the round trip delay value, the processor is configured to estimate the location of the mobile device based on a pseudo noise offset value and a phase value present in the signaling record.

21. The positioning determination engine of claim 15, wherein the processor is configured to assign, to the estimated location of the mobile device, a value representative of distance offset of estimated location from an actual location with an X percent confidence.
